(19) United States
(12) Patent Application Publication
(10) Pub. No.: US 2026/0140908 A1
(43) Pub. Date: May 21, 2026

(54) DATA STORAGE DEVICE WITH DUAL MEMORY SPACES ACCESSIBLE CONCURRENTLY BY A HOST USING DIFFERENT COMMUNICATION PROTOCOLS

(71) Applicant: Sandisk Technologies, Inc., Milpitas, CA (US)

(72) Inventors: Nihilesh K B, Coimbatore (IN); Ashok Kumar Kethe, Bangalore (IN)

(21) Appl. No.: 19/223,785

(22) Filed: May 30, 2025

Related U.S. Application Data
(63) Continuation-in-part of application No. 18/954,986, filed on Nov. 21, 2024.

(51) Int. Cl. G06F 13/40; G06F 13/38

(52) U.S. Cl. CPC G06F 13/4068; G06F 13/387; G06F 13/409

(57) ABSTRACT

A solid state device (SSD) includes two data storage controllers, each connected to a corresponding set of NAND chips. A first controller controls data transference between a first set of NAND chips and a host via a pair of full-duplex Tx/Rx lanes of a Universal Serial Bus (USB)-C connector. A second controller controls concurrent data transference between a second set of NAND chips and the host via a half-duplex D+/D− lane of the USB-C connector. In this manner, 20 Gigabits-per-second (Gbps) communications may be achieved using USB 3.2 Gen 2×2 while another 480 Megabits-per-second (Mbps) communication may be achieved using USB 2.0. The host may be configured to present the two sets of NAND chips to the user as two separate memory spaces, designated as separate drives. Similar features are described for use with volatile memory such as dynamic random access memory (DRAM) devices.

### CROSS-REFERENCE TO RELATED APPLICATIONS

This application is a continuation-in-part (CIP) of U.S. patent application Ser. No. 18/954,986, filed Nov. 21, 2024, having Attorney Docket No. WDT-1463 (WDA-7797-US), entitled “DATA STORAGE DEVICE WITH DUAL MEMORY SPACES ACCESSIBLE BY A HOST USING DIFFERENT COMMUNICATION PROTOCOLS BASED ON THE MATING ORIENTATION OF A REVERSIBLE CONNECTOR,” the entire contents of which is incorporated herein by reference.

### FIELD

The disclosure relates, in some aspects, to data storage devices such as solid state devices with non-volatile memory (NVM) arrays. More specifically, but not exclusively, the disclosure relates to solid state devices with Universal Serial Bus (USB) Type-C connectors.

### INTRODUCTION

In consumer electronics, solid state drives (SSDs) or other data storage devices incorporating non-volatile memories (NVMs) are often replacing or supplementing conventional hard disk drives for mass storage. The non-volatile memories may include one or more flash memory devices, such as NAND flash memories. The NVMs may also include multiple NAND flash dies or chips that form the NVM. Other data storage devices employ volatile memory such as dynamic random access memory (DRAM). Within SSDs and other data storage devices, it is important to maximize drive capacity without significantly increasing costs or power consumption. Herein, systems, methods and apparatus are provided to that end.

### SUMMARY

The following presents a simplified summary of some aspects of the disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One embodiment of the disclosure provides a data storage device that includes: a connector configured to couple the data storage device to a host with first and second full-duplex communication lanes and a half-duplex communication lane; a first data storage controller coupled to a first memory of the data storage device and coupled to both the first and second full-duplex communication lanes of the connector; and a second data storage controller coupled to a second memory of the data storage device and coupled to the half-duplex communication lane of the connector. The connector may be, for example, a Universal Serial Bus Type-C (USB-C) connector. The first and second full-duplex communication lanes may be, for example, first and second Tx/Rx lanes of the USB-C connector. The half-duplex lane of the connector may be, for example, the D+/D− lane of the USB-C connector. In some aspects, the data storage device provides concurrent communications with the host using two 10 Gbps lanes (for 20 Gbps) and one USB 2.0 lane.

Another embodiment of the disclosure provides a method for use by a data storage device that includes a connector, a first memory and a first data storage controller, and a second memory and a second data storage controller. The method includes: using the first data storage controller to couple the first memory to first and second full-duplex communication lanes of the connector; using the second data storage controller to couple the second memory to a half-duplex communication lane of the connector; transferring data, using the first data storage controller, between the first memory and a host using both the first and second full-duplex communication lanes of the connector; and transferring data, using the second data storage controller, between the second memory and the host using the half-duplex communication lane of the connector.

Yet another embodiment of the disclosure provides an apparatus that includes: means within a first data storage controller for coupling a first memory to first and second full-duplex communication lanes of a connector; means within a second data storage controller for coupling a second memory to a half-duplex communication lane of the connector; means within the first data storage controller for transferring data between the first memory and a host using both the first and second full-duplex communication lanes of the connector; and means within the second data storage controller for transferring data between the second memory and the host using the half-duplex communication lanes of the connector. In some examples, the connector is a USB-C connector, the means for controlling data transfer between the first memory and the host using both the first and second full-duplex lanes comprises means for controlling data transfer using USB 3.0 or higher, and the means for controlling data transfer between the second memory and the host using the half-duplex lane comprises means for controlling data transfer using USB 2.0.

### BRIEF DESCRIPTION OF THE DRAWINGS

FIG. 1 is a schematic block diagram configuration for an exemplary solid state device (SSD) and USB-C connection port socket, according to the prior art.

FIG. 2A is a schematic diagram of a USB-C socket, according to the prior art.

FIG. 2B is a schematic diagram of a USB-C plug, according to the prior art.

FIG. 3 is a schematic block diagram of an exemplary SSD and USB-C connection port socket, wherein the SSD has dual memory spaces or partitions and dual data storage controllers, with concurrent communication enabled with a host over dual connection lanes with different communication protocols depending upon the USB-C plug/socket mating orientation, in accordance with aspects of the present disclosure.

FIG. 4A is a schematic diagram of an SSD with a USB-C plug/pocket in a first mating orientation that provides access by the host to a first memory partition via the USB 10 Gigabits-per-second (Gbps) communication protocol and to a second memory partition via the USB 2.0 communication protocol, in accordance with aspects of the present disclosure.

FIG. 4B is a schematic diagram of an SSD with the USB-C plug/pocket in a second, opposite mating orientation that provides access by the host to the first memory partition via USB 2.0 and to the second memory partition via a USB 10 Gbps, in accordance with aspects of the present disclosure.

FIGS. 5A and 5B are schematic diagrams of an SSD with a USB-C plug/pocket, illustrating a use case wherein a background backup is performed with the speed of the backup depending upon the mating orientation, in accordance with aspects of the present disclosure.

FIG. 6 is a block diagram of a system including a host, a USB-C connection cable, and an SSD, wherein the SSD has dual memory spaces and dual data storage controllers, wherein concurrent communication enabled with a host over dual connection lanes with different communication protocols depending upon the USB-C plug/socket mating orientation, in accordance with aspects of the present disclosure.

FIG. 7 is a schematic block diagram configuration for an exemplary apparatus, such as an SSD, configured according to aspects of the present disclosure.

FIG. 8 is a schematic block diagram configuration for an exemplary data storage device configured according to aspects of the present disclosure.

FIG. 9 illustrates an exemplary procedure according to aspects of the present disclosure.

FIG. 10 is a schematic block diagram of another exemplary SSD and USB-C connection port socket, wherein the SSD has dual memory spaces or partitions and dual data storage controllers, with concurrent communication enabled with a host over two 10 Gbps lanes (for 20 Gbps) and one USB 2.0 lane, in accordance with aspects of the present disclosure.

FIG. 11A is a schematic diagram of an SSD with a USB-C plug/pocket in a first mating orientation that provides access by the host to a first memory partition at 20 Gbps and to a second memory partition via the USB 2.0 at 480 Mbps, in accordance with aspects of the present disclosure.

FIG. 11B is a schematic diagram of an SSD with the USB-C plug/pocket in a second, opposite mating orientation that also provides access by the host to the first memory partition at 20 Gbps and to the second memory partition via the USB 2.0 at 480 Mbps, in accordance with aspects of the present disclosure.

FIG. 12 is a schematic block diagram configuration for an exemplary apparatus, such as an SSD configured for concurrent communication with a host over two 10 Gbps lanes (for 20 Gbps) and one USB 2.0 lane according to aspects of the present disclosure.

FIG. 13 is a schematic block diagram configuration for an exemplary data storage device configured according to aspects of the present disclosure.

FIG. 14 illustrates an exemplary procedure according to aspects of the present disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Some aspects herein relate to portable data storage devices (DSD) having non-volatile memory (NVM), such as solid-state devices (SSDs), e.g., NAND flash memory storage devices (herein “NANDs”). (A NAND is a type of non-volatile storage technology that does not require power to retain data. It exploits negative-AND, i.e., NAND, logic.) To provide a concrete example, a portable SSD having one or more NVM NAND dies will be used below in the description of various embodiments. The SSD may be connected to a host via a flexible connection cable or may be configured as a thumb drive for directly mounting to a host such as a laptop computer or smart phone. It is understood that at least some aspects described herein may be applicable to other forms of SSDs as well. For example, at least some aspects described herein may be applicable to phase-change memory (PCM) arrays, magneto-resistive random access memory (MRAM) arrays, and resistive random access memory (ReRAM) arrays. Features may be implemented within a CMOS direct bonded (CBA) NAND chip or die (wherein CMOS refers to a complementary metal-oxide-semiconductor). Features may also be implemented within 3D XPoint memory cores, ferroelectric random-access memory (FeRAM) cores, and other types of memory cores. In some embodiments, one or more of the memory modules or portions thereof may be configured as other types of storage class memory (SCM).

Generally speaking, the memory modules may include any of a variety of Random Access Memory (RAM), dynamic RAM (DRAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

Additional aspects herein relate to SSDs configured for use with Universal Serial Bus (USB) Type-C (herein “USB-C”) cables and connectors or similar reversible connectors. Notably, USB-C refers to the configuration of cables and connectors (i.e., the connection plugs and sockets). USB-C is not communication protocol. The USB-C connectors have two-fold rotational symmetry enabling a USB-C plug to be inserted into a corresponding USB-C socket (or receptacle) in either of two orientations. That is, the plugs and sockets have a physically symmetric pinout. Electrically, however, USB-C connectors are not symmetric and the two ends of a USB-C cable are electrically different due to the cable wiring. For the user standpoint, USB-C cables often appear symmetric because software within the devices that the cables interconnect are configured to make the plugs, sockets, and cables behave as though symmetric.

Various communication protocols are compatible with USB-C cables, including USB4. Under the USB4 standard, devices must support a data communication bit rate of at least 20 gigabits (Gbit/s or Gbps) (e.g., 10 Gbps for each of two concurrent lanes) and may enable rates of 40 Gbit/s (USB4 version 1.0) and 80 Gbit/s (USB4 version 2.0). USB4 is currently only defined for the USB-C connector. The USB4 standard mandates backwards compatibility to USB 2.0 and USB 3.x, where x is 0, 1, or 2. USB 3.2 (aka USB 10 Gbps) provides for (or specifies) 10 Gbps transmission rates. USB 2.0 provides for (or specifies) 480 Mbps. Note that, herein, the USB-C cables used in the various embodiments are “Full-Featured”Type C cables compatible with USB4 and USB 3. There are also USB 2.0 Type-C cables compatible with only USB 2.0. Some aspects of the disclosure are also compatible with other (non-USB) reversible connectors, as discussed below.

TABLE I lists current USB standards (versions or protocols) and connectors:

TABLE I

| USB | | | Original | Current | USB |
|---|---|---|---|---|---|
| Version | Max. Speed | | USB Name | USB Name | Connectors |
| 1.1/1.0 | 12 | Mbps | — | — | Type-A, |
| | | | | | Type-B |
| 2.0 | 480 | Mbps | Hi-Speed | — | Type-A, |
| | | | USB | | Type-B, |
| | | | | | Type-C, |
| | | | | | Mini, Micro |
| 3.0 | 5 | Gbps | SuperSpeed | USB 5 Gbps | Type-A, |
| 3.1 Gen 1/ | | | USB | | Type-B, |
| 3.2 Gen 1 | | | | | Type-C, |
| | | | | | Micro |
| 3.1 Gen 2/ | 10 | Gbps | SuperSpeed | USB 10 Gbps | Type-A, |
| 3.2 Gen 2 | | | USB 10 Gbps | | Type-C |
| 3.2 Gen | 20 | Gbps | SuperSpeed | USB 20 Gbps | Type-C |
| 2x2 | | | USB 20 Gbps | | |
| USB4 | 20/40 | Gbps | — | USB 20 Gbps/ | Type-C |
| | | | | USB 40 Gbps | |
| USB4 | 80 | Gbps | — | — | Type-C |
| Version 2 | | | | | |

(USB 2.0)

### Overview

Data storage product capacities are often limited by memory technology limitations. In some SSD examples, using quad-level-cell (QLC) NAND technology, the maximum memory capacity of the SSD may be 8 Terabytes (TB). For example, the SSD may be configured with four NAND chips, each capable of storing 2 TB of data. The four 2 TB NAND chips are connected via four Flash Interface Module (FIM) channels to a single data storage controller, which may be configured as an application specific integrated circuit (ASIC).

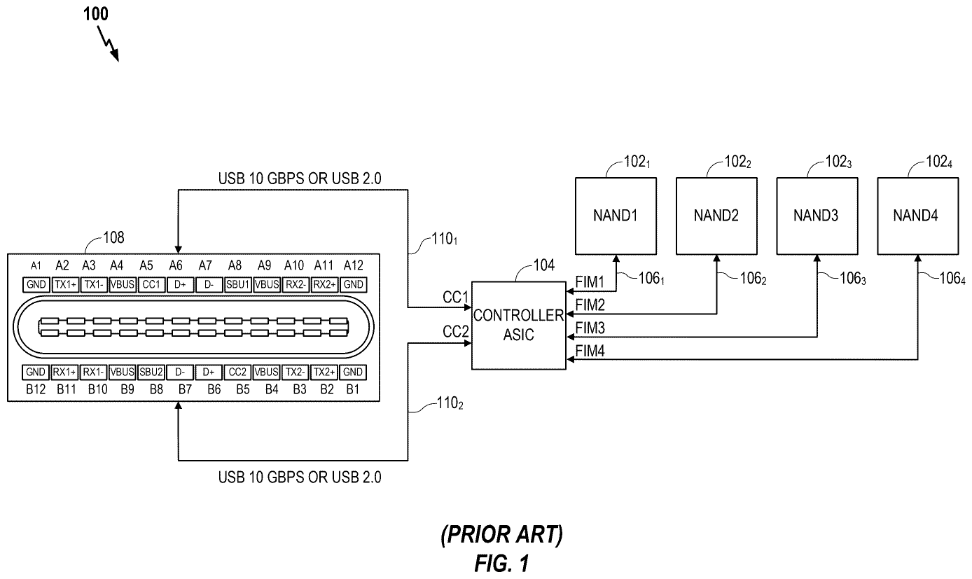

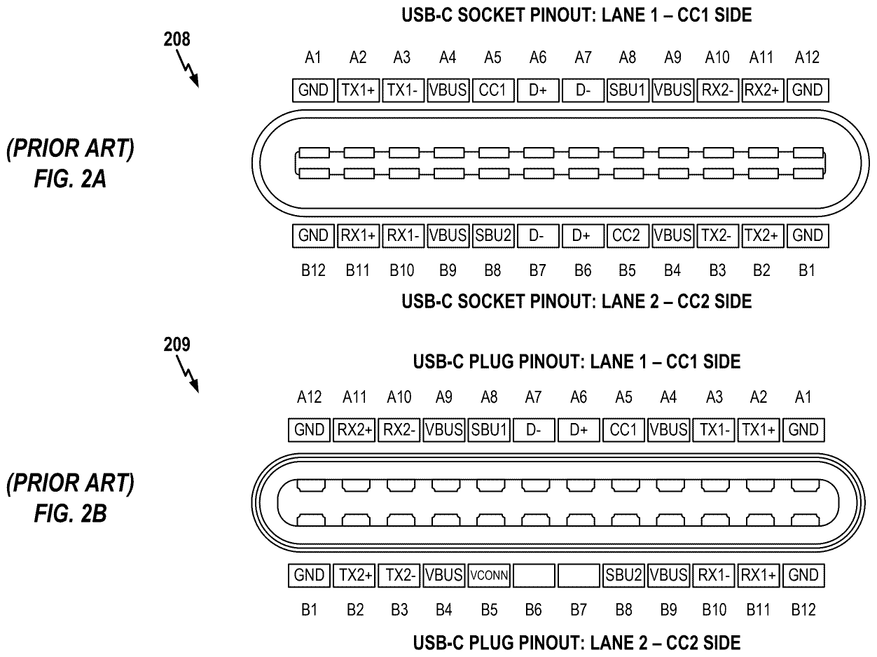

FIG. 1 illustrates a prior art example of an SSD 100 with four NAND chips 102₁-102₄ connected to a data storage controller 104 via four FIM channels 106₁-106₄. The SSD 100 also includes a USB-C connector socket (or receptable) 108 that accommodates two communication lanes. (See, also, FIG. 2 for an enlarged view of the USB-C connector socket pinout.) A first communication lane 110₁ is connected from the data storage controller 104 to a first row of pins of the USB-C connector socket 108. A second communication lane 110₂ is connected from the data storage controller 104 to a second row of pins in the USB-C connector socket 108. Although not shown in FIG. 1, the data storage controller 104 includes frontend components that implement a USB-C-compatible protocol (such as USB 10 Gbps) for use with the USB-C connector socket 108 and backend components that interface with the FIM channels that connect to individual NAND chips 102₁-102₄ of the SSD for storing (programming) data to the NAND chips and for reading (sensing) out data from the NAND chips. In other examples, the frontend components may be configured to operate at other rates, such as 12 Mbps, 480 Mbps, or 5 Gbps. Thus, the rate of 10 Gbps is just one example.

The data storage controller 104 of FIG. 1 is configured to provide a throughput of 10 Gbps from the NAND chips to an external host via the USB-C connector socket and a USB-C cable via either the first lane or the second lane, depending upon the orientation of the USB-C connector plug that is inserted into the USB-C connector socket. That is, the exemplary SSD 100 of FIG. 1 is not capable of 20 Gbps data transfer, even though the USB-C cable and the host may be capable of 20 Gbps data transfer (or even higher rates, such as 40 Gbps or 80 Gbps). The SSD 100 of FIG. 1 is capable of only 10 Gbps, either using lane 110₁ or lane 110₂, because its data storage controller and its FIM channels are only capable of a maximum of 10 Gbps (e.g., they are configured for use with USB 10 Gbps). To accommodate 20 Gbps, the SSD would require more expensive components that require more power and generate more heat, such as data storage controller ASICs configured for use with USB4 rather than USB 10 Gbps. Thus, SSD 100 of FIG. 1 is capable of either transferring data at 10 Gbps via lane 110₁ or transferring data at 10 Gbps via lane 110₂, but not both concurrently. The SSD 100 of FIG. 1 is also provided with only a total of four NAND chips providing 8 TB of memory.

FIG. 2 provides an enlarged view of a conventional USB-C connector socket 208, which is configured to receive a USB-C connector plug 209 of an external USB-C cable that may be connected into a host, such as a laptop computer of a user. The USB-C connector socket 208 has a physically symmetric pinout with two sets of signal pins, one on the top row and one on the bottom row, that are physically aligned with one another so the USB-C connector plug can be inserted into the USB-C connector socket 208 in either of two opposite mating orientations. As such, the USB-C connector plug is reversible and can be removed from the USB-C connector socket 208, its orientation flipped, then re-inserted into the USB-C connector socket 208 and it will again fit. However, the pinout of the USB-C connector socket 208 and the corresponding USB-C connector plug 209 are not electrically symmetric.

The electrical interface provided when the USB-C connector plug 209 is inserted in one orientation differs from the electrical interface provided when the USB-C connector plug 209 is inserted in the opposite orientation. Notably, one set of pins (e.g., the upper set) in the socket 208 has a configuration channel 1 (CC1) pin and the other set in the socket 208 (e.g., the lower set) has a CC2 pin. However, in the corresponding plug 209, the pinout includes only a single CC pin (CC1). There is no corresponding CC2 pin in the plug. As such, either the CC1 of the plug is connected to the CC1 of the socket (with the CC2 of the socket not connected to a corresponding CC pin) or the CC1 of the plug is connected to the CC2 of the socket (with the CC1 of the socket not connected to a corresponding CC pin). This enables the host and the SSD to detect the orientation of the USB-C connector plug to enable the correct lane for communication (i.e., lane 110₁ or 110₂ of FIG. 1). If CC1 of the plug is electrically connected to the CC1 of the socket, the first lane 110₁ is enabled and used for communication. If the USB-C connector plug is reversed, CC1 of the plug is electrically connected to CC2 of the socket and the second lane 110₂ is enabled and used for communication. (Note that the VCONN pin of the USB-C plug can also function as a configuration channel pin. Thus, if the SSD has a plug, rather than a socket, one of the lanes of the SSD can be connected to the CC1 of the plug while the other lane of the SSD can be connected to the VCONN pin. Thus, herein, the VCONN pin is also considered to be a configuration orientation pin.)

Thus, when using the SSD of FIG. 1, the user of the host can access the four NAND chips (for a total of 8 TB of memory) via either the first or second lanes (110₁ and 110₂). From the user's point of view, the orientation of the USB-C connector plug does not matter and so the plug can be inserted in either orientation. However, the SSD is provided with only 8 TB of total memory. It would be desirable to instead provide an SSD with 16 TB of memory, yet without requiring the provision of a more expensive and more power consuming (and more heat generating) data storage controller equipped to accommodate the 16 TB of memory. In the following, a solution to this problem is provided.

Briefly, an SSD is described herein that includes two (relatively inexpensive) data storage controller ASICs, each configured to accommodate a total memory space of 8 TB with a data transfer throughput of 10 Gbps (e.g., USB 10 Gbps) or a lower rate such as 480 Mbps of USB 2.0. A first set of four 2 TB NAND chips is coupled to a first data storage controller, and a second set of four 2 TB NAND chips is coupled to a second data storage controller, for a total of 16 TB, thus doubling the capacity of the SSD of FIG. 1. One lane of the USB-C connector socket is connected to the first data storage controller and its corresponding NANDs. The second lane of the USB-C connector socket is connected to the second data storage controller and its corresponding NANDs. At any given time, depending upon the mating orientation of the plug in the socket, only one of the two CC pins (CC1 or CC2) of the socket is connected to the corresponding CC1 pin of the plug to enable either the first lane or the second lane to be active for 10 Gbps signaling. Thus, only one of the two sets of NAND chips is accessible at 10 Gbps to the user via the host.

However, the other one of the data storage controllers can currently transfer data at 480 Mbps in accordance with USB. 2.0. Referring again to FIGS. 2A and 2B, the USB-C socket pinout includes two pairs of TX/RX and two pairs of D+/D−, as well as the two CC pins. For a single lane operation (USB 10 Gbps), only one set of the pins is used. The CC pins (CC1 and CC2) are used to detect the orientation of the cable and enable the correct lane for communication. Note that the USB-C plug includes only one D+/D− pair, which is on lane 1. Upon connecting the SSD with the USB-C cable (which connects the SSD with the host), there is only one lane of D+ and D− travelling inside the cable, unlike TX and RX. This lane is used for USB 2.0 communications while USB 10 Gbps communications are concurrently performed.

Thus, in some aspects, one lane within the SSD is used for USB 10 Gbps (via one of the two data storage controllers) while the other lane uses USB 2.0 (via the other of the two data storage controllers), allowing for concurrent transmissions of data at 10 Gbps and at 480 Mbps. Depending upon the mating orientation of the plug in the socket, either lane 1 is used for 10 Gbps and lane 2 is used for at 480 Mbps, or lane 1 is used for 480 Mbps and lane 2 is used for 10 Gbps. When the user connects the SSD in the first mating orientation, lane 1—which connects to the first data storage controller and its NANDs on “side 1” of the SSD—is enabled for access by the host to the first set of NAND chips at 10 Gbps. Concurrently, lane 2—which connects to the second data storage controller and its NANDs on “side 2” of the SSD—is enabled for access by the host to the second set of NAND chips at 480 Mbps via USB 2.0. If the user flips the USB-C connection plug (or flips the SSD itself) and re-connects the SSD to the host, lane 2 is enabled for access to the second set of NAND chips by the host at 10 Gbps. Concurrently, lane 1 is enabled for access to the first set of NAND chips by the host at for 480 Mbps via USB 2.0. That is, a flip of the USB-C connector plug within the SSD's USB-C connector socket enables the user to switch the storage space access speeds when accessing the two 8 TB memory spaces. The total 16 TB of storage space is accessible in either case.

The SSD may be connected to a host via a cable or the SSD might be configured as a thumb drive (or memory stick, pen drive, etc.) for directly attaching to a host, depending upon the particular communication protocol or interface. (For USB-C, since the pinout of a USB-C plug is different from the pinout of a USB-C socket, some of the devices and procedures described herein might not work with a thumb drive configured with only a USB-C plug. This may depend on whether the plug is provided with two pairs of D+ and D− pins, as with the socket. For other interfaces besides USB-C, such as Thunderbolt 4, at least some of the devices and procedures described herein may work for a thumb drive, depending upon the particular pinouts of the plug.) If a cable is used, the cable may be flipped and then re-inserted into the socket of the SSD. If the SSD is configured as a thumb drive, the thumb drive itself may be disconnected from the host, flipped, and then reattached. Note also that the USB2.0 (480 Mbps) lane/protocol could also be USB1.1 (12 Mbps). That is, USB2.0/1.1. Similarly, the 10 Gbps could instead be 5 Gbps. That is, the USB 2.0/USB 10 Gbps configuration is just one example.

Further, in some aspects, background data transfers may be performed to one of the sets of NAND chips at USB 2.0 while the user accesses the other set of NAND chips at 10 Gbps, e.g., for computer gaming or the like. In still other aspects, automatic data backups from the host may be performed in the background via data transfers to one of the sets of NAND chips at USB 2.0 while the user accesses the other set of NAND chips at 10 Gbps. Herein, a background transfer refers to the transmission of data during non-busy periods. (For example, a metric may be defined that represents how busy or active a computing system is for comparison against a threshold. If the metric is below the threshold, background data transfers may be performed between host and SSD. The metric may be based, e.g., on the percentage of a CPU utilization percentage.) For example, a custom application may be deployed on various platforms that performs a background auto-backup of data from selected folders on a host to the SSD via a USB2.0/8 TB partition. In some aspects, the USB2.0/8 TB partition may be hidden from the user and only the other 8 TB partition (accessible via USB 10 Gbps) is exposed to the user for data transfers. The power circuitry in the SSD may be configured to control power based on the mating configuration. For example, the data storage controller that is connected to the lane operating at USB 2.0 may be delivered reduced power as compared to the data storage controller that is connected to the lane operating at USB 10 Gbps. Power reduction is optional. In other examples, both data storage controllers and their respective NANDs remained fully powered-up. In still other aspects, the host may be notified to inform the user that the different connection speeds may be obtained by flipping the mating orientation.

In this manner, 16 TB of memory space is provided to the user without requiring the use of more expensive data storage controller ASICs and, in some examples, without consuming significantly more power or generating significantly more heat.

In some examples, a portable SSD may be provided that can be easily flipped by the user to access a different “side” of the SSD (via reinsertion the USB-C connection plug in the opposite orientation) to mimic the manner by which one flips a record to listen to a different side of the record. The SSD may have, for example, different graphics on one side of the SSD compared to the other side surface, or may have different colors (e.g., red vs blue). This helps emphasize to the user that there are two separate memory spaces that are accessible concurrently at different connection speeds. In one aspect, one side of the SSD may be used for high speed transference of personal data (e.g., videos, computer game data, etc.), while the other side may be used for low speed transference of work data (e.g., spreadsheets, etc.). The file explorer in the host may be configured to shows two drives (e.g., a first 8 TB “drive” accessible via USB 10 Gbps and a second 8 TB drive accessible via USB 2.0) in addition to the local disk C of the host (which includes the host's operating system).

In still other embodiments, an SSD is provided that uses USB-C connection cables (or similar) to provide 20 Gbps communications with a host using the Tx/Rx lines of the cable in accordance with a USB 3.2 Gen 2×2 or higher, while concurrently providing 480 Mbps communications with the host in accordance with USB 2.0 over the D+/D− lines of the connector. For example, the SSD may have: a first data storage controller connected to the Tx/Rx lines to provide 20 Gbps access by the host to a first memory space composed of a first set of NANDs or DRAMs; and a second data storage controller connected to the D+/D− lines to provide concurrent 480 Mbps access by the host to a second memory space composed of a second set of NANDs or DRAMs. In other examples, USB 3.0 or 3.1 may be used instead of USB 3.2 Gen 2×2, though with slower overall speeds (e.g., 5 Gbps or 10 Gbps for the connection via the Tx/Rx lines). In still other examples, USB4 or faster protocols may be used. Herein, when referring to a protocol such as USB 3.0 or higher, the “higher” refers to more recent protocols such as USB 3.1, USB 3.2, or USB4 (sometimes also referred to as USB 4.0). These and other features will be described in detail in the following sections.

Exemplary SSD with Two Separate Memory Spaces and Memory Controllers

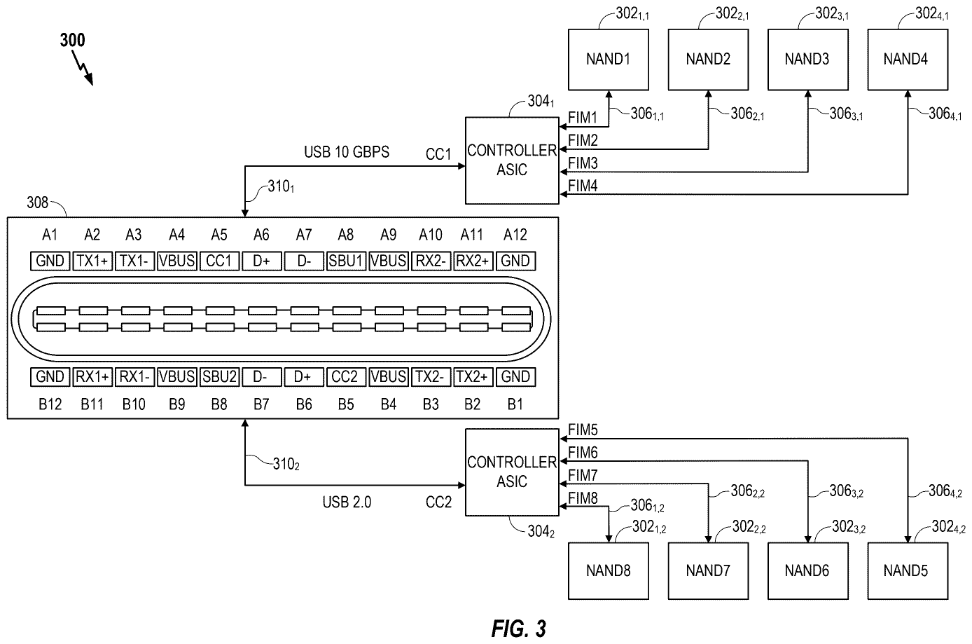

FIG. 3 illustrates an SSD 300 configured in accordance with aspects of the present disclosure wherein two data storage controllers are provided, each connected to four NAND chips, thus providing a total memory capacity of 16 TB. SSD 300 has a first set of four NAND chips 302_{1.1}-302_{4.1} connected to a first data storage controller 304₁ via four FIM channels 306_{1.1}-306_{4.1}. The SSD 300 also includes a USB-C connector socket (or receptable) 308 (see, again, FIG. 2) that accommodates two communication lanes. A first communication lane 310₁ is connected from the data storage controller 304₁ to a first row of pins of the USB-C connector socket 308. The second communication lane 310₂ is connected to a second data storage controller 304₂ via a second row of pins in the USB-C connector socket 308. The second data storage controller 304₂ is connected to a second set of four NAND chips 302_{1.2}-302_{4.2} via four FIM channels 306_{1.2}-306_{4.2}. Although not shown in FIG. 3, each of the two data storage controllers 304₁, 304₂ includes frontend components that implements at least two USB-C-compatible protocols (such as USB 10 Gbps and USB 2.0) for use with the USB-C connector socket 308 and backend components that interface with the corresponding FIM channels that connect to the corresponding NAND chips of the SSD for storing (programming) data to the NAND chips and for reading out (sensing) data from the NAND chips.

The two data storage controllers 304₁, 304₂ of FIG. 3 are each configured to provide a throughput of either 10 Gbps or 480 Mbps from the NAND chips to an external host via the USB-C connector socket and a USB-C cable via its corresponding lane. However, only one of the two lanes 310₁, 310₂ is enabled at any given time for USB 10 Gbps based on the mating orientation of the USB-C connector plug (see, again, FIG. 2) in the USB-C connector socket 308, while the other of the two lanes is enabled for USB 2.0 480 Mbps. The CC pins (CC1 and CC2) of the USB-C connector socket 308 are used by the host and the SSD 300 to detect the orientation of the USB-C connector plug to enable a particular lane for 10 Gbps communication (i.e., lane 310₁ or 310₂) while the other lane is enabled for concurrent 480 Mbps communication. As noted above, when the USB-C plug is inserted, only one of the two CC pins in the USB-C socket is electrically connected to the host. If CC1 is electrically connected, then the first lane 310₁ is enabled for USB 10 Gbps (as shown) and NAND chips 302_{1.1}-302_{4.1} are accessible to the host at that speed, while the other lane 310₂ is enabled for USB 2.0 (as shown) and NAND chips 302_{1.2}-302_{4.2} are accessible to the host at the slower speed of 480 Mbps. If the USB-C connector plug is reversed (flipped), then CC2 is electrically connected and the second lane 310₂ is enabled for USB 10 Gbps and NAND chips 302_{1.2}-302_{4.2} arc accessible to the host at that speed, while the other lane 110₁ is enabled only for USB 2.0 and NAND chips 302_{1.1}-302_{4.1} are accessible to the host at that slower speed. (This alternative configuration where lane 1 is USB 2.0 and lane 2 is USB 10 Gbps is not shown in FIG. 3.) Note also that the USB2.0 (480 Mbps) lane/protocol could also be USB1.1 (12 Mbps). That is, USB2.0/1.1. Similarly, the 10 Gbps could instead be 5 Gbps. That is, the USB 2.0/USB 10 Gbps configuration is just one example.

Notably, both data storage controller 304₁ and data storage controller 304₂ can be relatively inexpensive data storage controller ASICs configured to use with a maximum of four FIMs at a maximum throughput of 10 Gbps. Moreover, in some examples, whichever data storage controller is currently being used for USB 2.0 can use reduced power to reduce overall power consumption and reduce heat. If the USB-C connector plug is then reversed by the user, the opposite lane is enabled, and so the data storage controller that was being given reduced power is powered up, whereas the other data storage controller is a now given reduced power. In some examples, one set of NAND chips may be used by a user for personal data (e.g., videos, computer game data, etc.), while the other set of NAND chips may be used for work data (e.g., spreadsheets, etc.) In other examples, one set of NAND chips may be used by the user for primary data storage while the other set of NAND chips may be used for data backup.

As noted above, one set of NAND chips may be regarded as representing one “side” of the SSD, whereas the other set of NAND chips may be regarded as representing the other “side” of the SSD. To access a first side of the SSD using USB 10 Gbps, the USB-C plug is inserted into the USB-C socket in one orientation. To access the other side of the SSD at USB 10 Gbps, the USB-C plug may be removed, the SSD flipped up-side-down, and then the plug is reinserted into the USB-C socket. Alternatively, the USB-C plug is flipped, then reinserted.

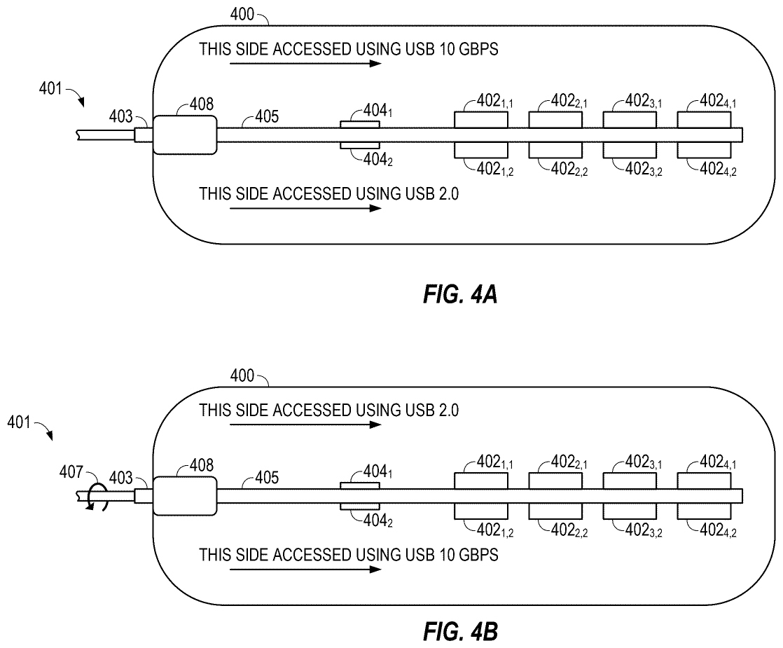

FIGS. 4A and 4B further illustrate how one “side” or the other of an SSD may be accessed using USB 10 Gbps while the other side is accessed using USB 2.0, either by flipping the USB-C cable plug and then reinserting the plug into the SSD or, equivalently, by flipping the SSD and then reinserting the USB-C cable plug into the SSD.

FIG. 4A illustrates an SSD 400 with a USB-C cable 401 having a USB-C cable plug 403 inserted into a USB-C cable socket 408. Although not shown in the figure, the opposite end of the USB-C cable 401 is connected into a host. In the orientation of FIG. 4A, a data storage controller 404₁ is enabled to provide access by the host to a first set of NAND chips 402_{1.1}-402_{4.1} with data transfers to/from the host performed using USB 10 Gbps while a data storage controller 404₂ is enabled to provide access by the host to a second set of NAND chips 402_{1.2}-402_{4.2} with data transfers to/from the host performed using USB 2.0. Note that the figure shows a central bar 405 that conceptually represents various connection lanes, busses and/or FIMs that interconnect the various components. Notably, as explained above, separate FIMs and connection lanes are provided for the two separate data storage controllers and their corresponding NAND chips. For clarity, the separate lanes, FIMS, etc., are omitted.

FIG. 4B illustrates the SSD 400 with the USB-C cable 401 flipped (as shown by arrow 407) with its USB-C cable plug 403 inserted into the USB-C cable socket 408 in the opposite orientation. In the configuration of FIG. 4B, data storage controller 404₂ is enabled to provide access by the host to the first set of NAND chips 402_{1.2}-402_{4.2} with data transfers to/from the host performed using USB 10 Gbps while data storage controller 404₁ is enabled to provide access by the host to the first set of NAND chips 402_{1.1}-402_{4.1} with data transfers to/from the host performed using USB 2.0. Alternatively, the SSD itself may be flipped, with the USB-C cable plug reinserted so as to flip the orientation of the plug in the socket without flipping the plug. Note that, in some examples, the first side of the SSD (i.e., NAND chips 402_{1.1}-402_{4.1}) may be used for storing work (or official data) such as spreadsheets, filed, etc., whereas the other side of the SSD (i.e., NAND chips 402_{1.2}-402_{4.2}) may be used for storing personal data such as videos, movies, etc.

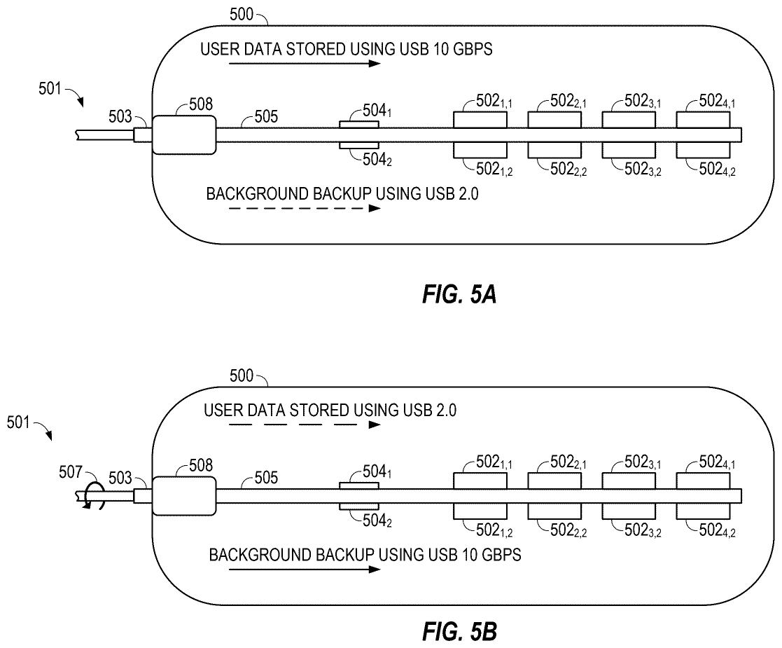

FIGS. 5A and 5B illustrates a use case in which one side of an SSD may be used by user for storing data using USB 10 Gbps while, concurrently, an automatic background backup of host data is performed on the other side of the SSD using USB 2.0. In some examples, the host does not show the second (side 2) partition of the drive within the file explorer of the host, only the side 1 partition. In other examples, both partitions are shown. As noted above, a custom application may be deployed on various platforms that performs a background auto-backup of data from selected folders on a host to the SSD via USB2.0.

FIG. 5A illustrates an SSD 500 with a USB-C cable 501 having a USB-C cable plug 503 inserted into a USB-C cable socket 508. Although not shown in the figure, the opposite end of the USB-C cable 501 is connected into a host operator by a user. In the orientation of FIG. 5A, a data storage controller 504₁ is enabled to provide access by the user at 10 Gbps to a first set of NAND chips 502_{1.1}-502_{4.1} for storage of data that may be, e.g., work data, personal data, or a combination of both. Concurrently, an automatic background backup is performed by the host using USB 2.0 to a second set of NAND chips 502_{1.2}-502_{4.2}. This backup may be transparent to the user who is only made aware by the host OS of the first partition corresponding to NAND chips 502_{1.1}-502_{4.1}. In other examples, the user is made aware of the partition/backup, as well as the backup speed of 480 Mbps.

FIG. 5B illustrates the SSD 500 with the USB-C cable 501 flipped (as shown by arrow 507) with its USB-C cable plug 503 inserted into the USB-C cable socket 508 in the opposite orientation. In the configuration of FIG. 5B, access by the user to the first partition NAND chips 502_{1.1}-502_{4.1} is only at 480 Mbps, while the backup is performed to the second partition NAND chips 502_{1.2}-502_{4.2} at 10 Gbps. This may be appropriate if, for example, the user wants to provide a very fast backup (10 Gbps) and does not currently need fast access to the data within the first partition NAND chips 502_{1.1}-502_{4.1}. The figures show a central bar 505 that conceptually represents various connection lanes, busses and/or FIMs that interconnect the various components. The separate lanes, FIMS, etc., are omitted in FIGS. 5A and 5B.

Note also that the host devices described herein may be referred to as having a Downstream Facing Port (DFP), i.e. a USB port functioning as a host and power source. The SSDs described herein may be referred to as having an Upstream Facing Port (UFP), i.e., a USB port serving as a client and power sink. At least some aspects of the disclosure may also be applicable to a Dual Role Device (DRD), which is capable of functioning as either a host or client (and formerly referred to as an on-the-go (OTG) device). At least some aspects of the disclosure may also be applicable to Dual Role Power (DRP) devices, i.e., devices capable of operating as either a power provider or power consumer. Note also that the CC pins discussed above not only enable detection of cable orientation (mating orientation), the pins enable identifying device roles to prevent damage and define communication hierarchy, and enable negotiating of power configurations between client and host devices for power distribution.

U.S. patent application Ser. No. 18/954,904, filed on Nov. 21, 2024, entitled “DATA STORAGE DEVICE WITH DUAL MEMORY SPACES ENABLED BASED ON THE MATING ORIENTATION OF REVERSIBLE CONNECTOR,” (Atty. Docket No. WDT-1462 (WDA-7823-US))), and assigned to the assignee of the parent of the present application, is fully incorporated by reference herein for all purposes, and it should be understood that various features and inventions of the present application and the incorporated application can be practiced together. By way of example and not limitation, an SSD may be provided that is configured to either (a) enable concurrent operation of both data storage controllers and connection lanes to permit, e.g., USB 10 Gbps protocol data transfers via one of the connection lanes and simultaneous 480 Mbps USB 2.0 protocol transfers via the other of the connection lanes or (b) fully disconnect one of its data storage controllers and connection lanes depending upon the mating orientation of the USB-C plug as described in the incorporated application.

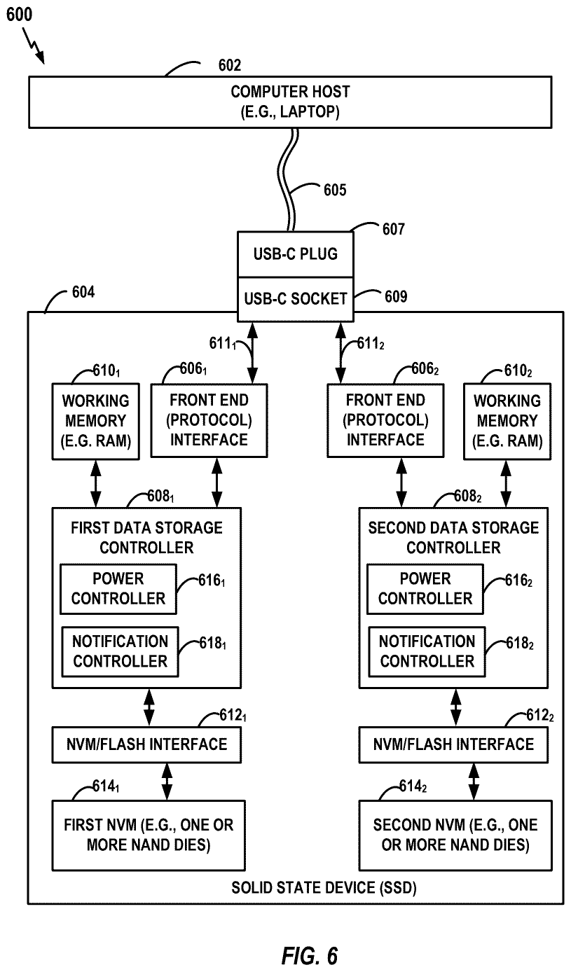

FIG. 6 is a block diagram of a system 600 including an exemplary computer host 602 (e.g., a laptop) and a solid state device (SSD) 604 configured with two data storage controllers and two NVM arrays. The host 602 is connected to the SSD 604 using an external USB-C connection cable 605 having a USB connection plug 607 for insertion into a USB-C connection socket 609 of the SSD in one of two mating orientations (as explained above).

The SSD 604 is configured to provide concurrent access to both the first and the second NVM array by the computer 602 with the connection speed/protocol depending upon the mating orientation. For example, in the first mating orientation, in which a first data storage controller 608₁ and a first NVM array 614₁ are communicatively coupled to the host 602 using USB 10 Gbps, the host 602 may provide a write command to the SSD 604 for writing user data to NVM 614₁ or a read command for reading user data from the NVM 614₁, with access by the host 602 to the NVM 614₁ under the control of data storage controller 608₁. Concurrently, the host 602 may provide a write command to the SSD 604 for writing user data to NVM 614₂ or a read command for reading user data from the NVM 614₂, with USB 2.0 access by the host 602 to the NVM 614₂ under the control of data storage controller 608₂.

In the second mating orientation, in which the second data storage controller 608₂ and the second NVM array 614₂ are communicatively coupled to the host 602 using USB 10 Gbps, the host 602 may provide a write command to the SSD 604 for writing user data to NVM 614₂ or a read command for reading user data from the NVM 614₂, with access by the host 602 to the NVM 614₂ under the control of data storage controller 608₂. Concurrently, the host 602 may provide a write command to the SSD 604 for writing user data to NVM 614₁ or a read command for reading user data from the NVM 614₁, with USB 2.0 access by the host 602 to the NVM 614₁ under the control of data storage controller 608₁.

The SSD 604 includes a front end (protocol) interface 606₁ for interfacing with host 602 via the USB-C-compatible protocol using a first connection lane 611₁. The SSD 604 also includes a working memory 610₁ (such as random access memory (RAM)), an NVM interface 612₁ (which may be referred to as a flash interface or backend interface), and the NVM 614₁, such as one or more NVM NAND dies or NVM arrays. The data storage controller 608₁ includes a power controller 616₁ and a notification controller 618₁. The power controller 616₁ provides full power to the data storage controller 608₁ (and other components such as working memory 610₁) while the USB plug 607 and USB socket 609 are in the first mating configuration, but reduces power to those components while the USB plug 607 and USB socket 609 are in the second mating configuration. The notification controller 618₁ notifies the host 602 of the NVM 614₁ that is accessible at USB 10 Gbps while the USB plug 607 and USB socket 609 are in the first mating configuration. The notification controller 618₁ also notifies the host 602 that the second NVM 614₂ instead can be accessed at USB 10 Gbps if the user flips the USB plug 607 and USB socket 609 to the second mating configuration. The host 602 can then notify the user of that option via an appropriate display screen indication.

The SSD 604 also includes a front end (protocol) interface 6062 for interfacing with host 602 via the USB-C-compatible protocol using a second connection lane 611₂. The SSD 604 also includes a working memory 610₂ (such as RAM), an NVM interface 612₂ (e.g., flash interface or backend interface), and the NVM 614₂, such as one or more NVM NAND dies or NVM arrays. The data storage controller 608₂ also includes a power controller 616₂ and a notification controller 618₂. The power controller 616₂ provides full power to data storage controller 608₂ (and other components such as working memory 610₂) while the USB plug 607 and USB socket 609 are in the second mating configuration, but reduces power to those components while the USB plug 607 and USB socket 609 are in the first mating configuration. The notification controller 618₂ notifies the host 602 of the NVM 614₂ that is accessible at USB 10 Gbps while the USB plug 607 and USB socket 609 are in the second mating configuration. The notification controller 618₂ also notifies the host 602 that the first NVM 614₁ instead can be accessed at USB 10 Gbps if the user flips the USB plug 607 and USB socket 609 to the first mating configuration. The host 602 can then notify the user of that option via an appropriate display screen indication.

Note that although the power controllers and notification controllers are shown as components of the data storage controllers, they may be implemented as separate components. Moreover, rather than having separate power controllers and notification controllers, as shown, a single power controller and/or single notification controller can instead be provided, i.e., as components that are separate from the data storage controllers.

In the primary examples herein, the host 602 is a laptop computer. However, host 602 may be any system or device needing data storage or retrieval and a compatible interface for communicating with the SSD 604. For example, the host 602 may be a computing device, a desktop computer, a personal computer, a portable computer, a workstation, a server, a personal digital assistant, a digital camera, an Internet of Things (IoT) device, or a mobile phone. Still further, in some examples, the host may be any other device accessible via USB-C or a similar communication interface having a reversible connection scheme.

In the primary examples described herein, the cable 605 provides a USB-C interface. However, in other examples, other suitable communication interfaces may be used, if configured with reversible connectors that can be physically coupled in one of two mating configurations, e.g., the connectors have a physically symmetric but electrically asymmetric pinout to thereby permit the mating orientation to be detected from the electrical asymmetry. For example, the Thunderbolt 4 interface is reversible. Aspects described herein may also be applicable to the Peripheral Component Interconnect Express (PCIe) interface. Future versions of USB interfaces are also expected to be reversible.

Note that the data storage controllers 608₁ and 608₂ of FIG. 6 may include any type of processing device, such as a microprocessor, a microcontroller, an embedded controller, a logic circuit, software, firmware, or the like, for controlling the operation of the SSD 604. In some aspects, some or all of the functions described herein as performed by one or both of the data storage controllers may instead be performed by another element of the SSD 604. For example, the SSD 604 may include a microprocessor, a microcontroller, an embedded controller, a logic circuit, software, firmware, or any kind of processing device, for performing one or more of the functions described herein as being performed by one or both of the data storage controllers.

The working memories 610₁ and 610₂ of FIG. 6 may be any suitable memory or system capable of storing data. For example, the memories may be ordinary RAM, DRAM, double data rate (DDR) RAM (DRAM), static RAM (SRAM), synchronous dynamic RAM (SDRAM), flash storage, an erasable programmable read-only-memory (EPROM), an electrically erasable programmable ROM (EEPROM), or the like. In various embodiments, the data storage controllers use the working memories, or portions thereof, to store data during the transfer (transference) of data between the host 602 and the NVMs. For example, the working memories or portions thereof may be a cache memory. The NVMs 614₁ and 614₂ may be any suitable type of non-volatile memory, such as a NAND-type flash memory or the like.

Although FIG. 6 shows an exemplary SSD that is configured as an SSD with flash NAND NVM, the various disclosed embodiments are not necessarily limited to an SSD application/implementation. The disclosed NVM dies and associated processing components can be implemented as part of a package that includes other processing circuitry and/or components. For example, a processor may include, or otherwise be coupled with, embedded NVM and associated circuitry and/or components. The processor could, as one example, offload certain tasks to the NVM and associated circuitry and/or components. Still further, the data storage device 604 may have volatile memory such as DRAM chips instead of NAND dies as its primary memory. That is, NVM 614₁ may instead be a first DRAM and NVM 614₂ may instead be a second DRAM. In such an implementation, the interfaces 612₁ and 612₂ would not be flash interfaces but double/dual data rate (DDR) interfaces for use with the DRAMs.

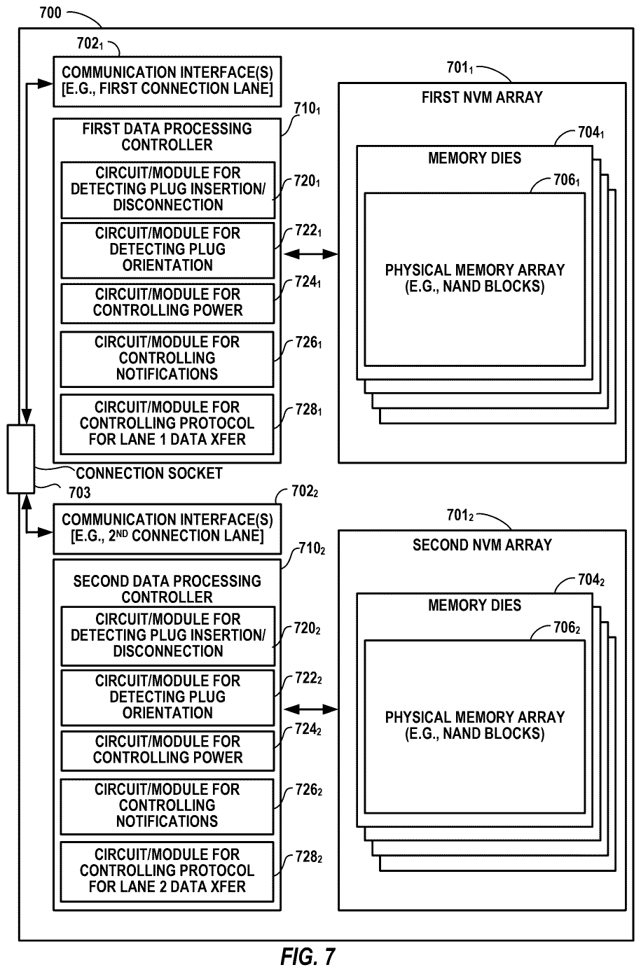

FIG. 7 illustrates an embodiment of an apparatus 700 configured according to one or more aspects of the disclosure. The apparatus 700, or components thereof, could embody or be implemented as a data storage controller within a portable SSD, or other type of device that supports computations and data storage.

The apparatus 700 has a first set of components denoted by subscript 1 and a second set of components denoted by subscript 2, whose operations may vary depending upon a plug orientation within a connection socket 703, which may be a USB-C connection socket. (In FIG. 7, the plug is not shown, but see, e.g., FIG. 6.) A first data processing controller 710₁ is communicatively coupled to a first NVM die array 701₁ that includes one or more memory dies 704₁, each of which may include physical memory arrays 706₁, e.g., NAND blocks. The data processing controller 710₁ may include various modules/circuits, including firmware (FW) components. These components can be coupled to and/or placed in electrical communication with one another and with the NVM die array 701₁ via suitable components, represented generally by connection lines in FIG. 7. Although not shown, other circuits such as timing sources, peripherals, voltage regulators, and power management circuits may be provided, which are well known in the art, and therefore, will not be described any further.

In some examples, the memory dies may include on-chip circuitry such as under-the-array circuitry. The memory dies 704₁ may be communicatively coupled to the data processing controller 710₁ such that the apparatus 700 can read or sense information from, and write or program information to, the physical memory array 706₁. That is, the physical memory array 706₁ can be coupled to controller 710₁ so that the physical memory array 706₁ is accessible by the controller 710₁. The dies may additionally include, e.g., input/output components, registers, voltage regulators, etc. The connection between the controller 710₁ and the memory dies 704₁ of the NVM die array 701₁ may include, for example, one or more busses.

The apparatus 700 includes a first communication interface 702₁, e.g. a first communication lane (lane 1), for connecting via socket 703 to a laptop, a mobile phone, etc. using, e.g., USB-C-compatible protocols (such as USB 10 Gbps or USB 2.0) other suitable communication protocols. More generally, the communication interface 702₁ provides a means for communicating with other apparatuses over a transmission medium. In some implementations, the communication interface 702₁ includes circuitry and/or programming (e.g., a program) adapted to facilitate the communication of information bi-directionally with respect to one or more devices in a system. In some implementations, the communication interface 702₁ may be configured for wire-based communication. For example, the communication interface 702₁ could be a send/receive interface or some other type of signal interface including circuitry for outputting and/or obtaining signals (e.g., signals to/from a host). The communication interface 702₁ serves as one example of a means for receiving and/or a means for transmitting.

The modules/circuits of the data storage controller 710₁ are arranged or configured to obtain, process, and/or send data, control data access and storage, issue or respond to commands, and control other desired operations. For example, the controller 710₁ may be implemented as one or more processors, configured individually or in combination, one or more controllers, and/or other structures configured to perform functions. According to one or more aspects of the disclosure, the controller 710₁ may be adapted to perform any or all of the features, processes, functions, operations, and/or routines described herein as being performed by the data storage controller. For example, the controller 710₁ may be configured to perform any of the data storage controller steps, functions, and/or processes described with respect to FIGS. 3-6 and FIGS. 8-9, discussed below.

As used herein, the term “adapted” in relation to the data processing controller 710₁ may refer to the modules/circuits being one or more of configured, employed, implemented, and/or programmed to perform a particular process, function, operation and/or routine according to various features described herein. The modules/circuits may include a specialized processor, such as an application-specific integrated circuit (ASIC) that serves as a means for (e.g., structure for) carrying out any one of the data storage controller operations described in conjunction with, e.g., FIGS. 3-6 and 8-9. The modules/circuits serve as an example of a means for processing. In various implementations, the modules/circuits may provide and/or incorporate, at least in part, functionality described above for the components in various embodiments shown, including for example data storage controller 608₁ of FIG. 6.

According to at least one example of the apparatus 700, the data processing controller 710₁ may include one or more of: a circuit/module 720₁ for detecting plug insertion/disconnection via communication interface 702₁ (see, again, the USB-C plugs/sockets discussed above and the electrical asymmetry of the CC1 and CC2 pins); a circuit/module 722₁ for detecting plug orientation (by detecting, e.g., a CC1 connection instead of a CC2 connection) and, in response to a CC1 connection, for enabling access by a host via an external cable to the first NVM array 701₁ via the first connection lane at USB 10 Gbps, or, in response to a CC2 connection, for enabling access by the host via the external cable to the first NVM array 701₁ via the first connection lane at USB 2.0 at 480 Mbps; a circuit/module 724₁ for controlling power (e.g., to provide full power to the subscript 1 components if CC1 is active but reduced power to the subscript 1 components if CC2 is instead active); a circuit/module 726₁ for controlling notifications sent to the host (as described above); and a circuit/module 728₁ for controlling the protocol for data transfer between the host and the first NVM array 701₁ based on the mating orientation (e.g., for providing USB 10 Gbps along lane 1 in the first mating configuration and USB 2.0 along lane 1 in the second mating configuration).

In at least some examples, means may be provided for performing the functions illustrated in FIG. 7 and/or other functions illustrated or described herein. For example, the means may include one or more of: means, such as circuit/module 720₁, for detecting plug insertion/disconnection via communication interface 702₁; means, such a circuit/module 722₁, for detecting plug orientation; means, such a circuit/module 724₁, for controlling power; means, such a circuit/module 726₁, for controlling notifications sent to the host; and means, such a circuit/module 728₁, for controlling the protocol for data transfer between the host and the first NVM array 701₁ based on the mating orientation (e.g., for providing USB 10 Gbps along lane 1 in the first mating configuration and USB 2.0 along lane 1 in the second mating configuration). In yet another aspect of the disclosure, a non-transitory computer-readable medium is provided that has one or more instructions which when executed by a processing circuit in an SSD causes the data storage controller of the SSD to perform one or more of the functions or operations listed above.

As noted, a second set of components is provided, which may be configured the same as the first set of components but which operate in accordance with USB 2.0 if the first set of components is operating in accordance with USB 10 Gbps, and operate in accordance with USB 10 Gbps if the first set of components is operating in accordance with USB 2.0. The second set of components will only briefly be described. A data processing controller 710₂ is communicatively coupled to a second NVM die array 701₂ that includes one or more memory dies 704₂, each of which may include physical memory arrays 706₂, e.g., NAND blocks. The apparatus 700 includes a second communication interface 702₂, e.g. a second communication lane, connected to the socket 703.

According to at least one example of the apparatus 700, the data processing controller 710₂ may include one or more of: a circuit/module 720₂ for detecting plug insertion/disconnection via communication interface 702₂; a circuit/module 722₂ for detecting plug orientation (by detecting, e.g., a CC1 connection instead of a CC2 connection) and, in response to a CC2 connection, for enabling access by a host via an external cable to the second NVM array 701₂ via the second connection lane at USB 10 Gbps, or, in response to a CC1 connection, for enabling access by the host via the external cable to the second NVM array 701₂ via the second connection lane at USB 2.0 at 480 Mbps; a circuit/module 724₂ for controlling power (e.g., to provide full power to the subscript 2 components if CC2 is active but reduced power to the subscript 2 components if CC1 is instead active); a circuit/module 726₂ for controlling notifications sent to the host (as described above); and a circuit/module 728₂ for controlling the protocol for data transfer between the host and the second NVM array 701₂ based on the mating orientation (e.g., for providing USB 10 Gbps along lane 2 in the second mating configuration and USB 2.0 along lane 2 in the first mating configuration).

According to at least one example of the apparatus 700, the processing controller 710₂ may include one or more of: means, such as circuit/module 720₂, for detecting plug insertion/disconnection via communication interface 702₂; means, such a circuit/module 722₂, for detecting plug orientation; means, such a circuit/module 724₂, for controlling power; means, such a circuit/module 726₂, for controlling notifications sent to the host; and means, such a circuit/module 728₂, for controlling the protocol for data transfer between the host and the first NVM array 701₂ based on the mating orientation (e.g., for providing USB 10 Gbps along lane 2 in the second mating configuration and USB 2.0 along lane 2 in the first mating configuration). In yet another aspect of the disclosure, a non-transitory computer-readable medium is provided that has one or more instructions which when executed by a processing circuit in an SSD causes the data storage controller of the SSD to perform one or more of the functions or operations listed above.

Still further, note that: circuit/modules 722₁ and 722₁ provide a means for detecting a connection of a second connector (e.g., a USB-C plug connector) with a first connector (e.g., a USB-C socket connector) in a first mating orientation. Circuit/module 728₁ provides a means, operative in response to detecting the connection of the second connector with the first connector in the first mating orientation, for enabling access by the host via an external cable to the first NVM array 704₁ under the control of the first data storage controller 710₁ with a first communication protocol. Circuit/module 728₂ provides means, also operative in response to detecting the connection of the second connector with the first connector in the first mating orientation, for enabling access by the host via the external cable to the second NVM array 704₂ under the control of the second data storage controller 710₂ with a second, different communication protocol. Circuit/modules 720₁ and 720₂ provide means for detecting a disconnection of the second connector from the first connector and, in response, for disabling access by the host to the first and second NVM arrays, respectively. Circuit/modules 722₁ and 722₁ provide means for detecting a connection of the second connector with the first connector in the second, different mating orientation with the first connector. Circuit/module 728₁ provides a means, operative in response to detecting the connection of the second connector with the first connector in the second mating orientation, for enabling access by the host via the external cable to the first NVM array 704₁ under the control of the first data storage controller 728₁ with the second communication protocol. Circuit/module 728₂ provides a means, operative in response to detecting the connection of the second connector with the first connector in the second mating orientation, for enabling concurrent access by the host via the external cable to the second NVM array 704₂ under the control of the second data storage controller 728₂ with the first communication protocol. In the first mating orientation, the first communication protocol may be USB 10 Gbps or higher and the second communication protocol may be USB 2.0. In the second mating orientation, the first communication protocol may be USB 2.0 and the second communication protocol may be USB 10 Gbps or higher.

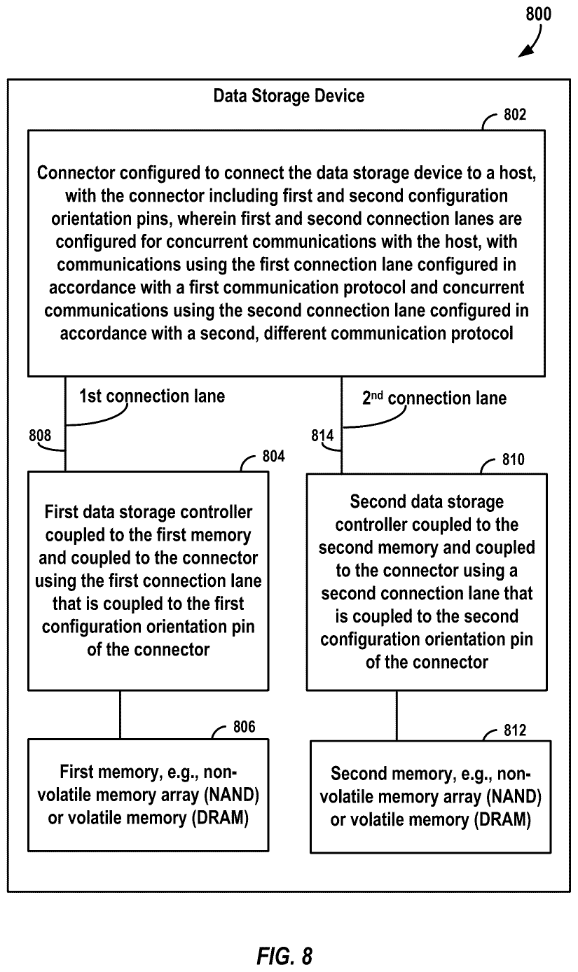

FIG. 8 is a block diagram of an exemplary data storage device 800 in accordance with some aspects of the disclosure. The data storage device 800 includes: a (first) connector 802 (such as a USB-C socket) configured to connect the data storage device to a host via an external (second) connector (such as a USB-C cable with a USB-C plug), with the connector 802 including first and second configuration orientation pins (e.g., CC1 and CC2). First and second connection lanes 808 and 814, respectively, are configured for concurrent communications with the host, with communications over the first connection lane configured in accordance with a first communication protocol and concurrent communications over the second connection lane configured in accordance with a second, different communication protocol. The data storage device 800 also includes: a first data storage controller 804 coupled to a first memory 806 (which may be an NVM such as a NAND or a volatile memory such as a DRAM) and coupled to the connector 802 using the first connection lane 808 that is coupled to the first configuration orientation pin (e.g., CC1) of the connector 802. The data storage device 800 also includes: a second data storage controller 810 coupled to a second memory 812 (which also may be an NVM such as a NAND or a volatile memory such as a DRAM) and coupled to the connector 802 using the second connection lane 814 that is coupled to the second configuration orientation pin (e.g., CC2) of the connector 802. Both of the connection lanes (808, 814) are communicatively coupled to the data storage device to the host via the connector 802 for concurrent communication, with communications over the first connection lane configured in accordance with a first communication protocol and concurrent communications over the second connection lane configured in accordance with a second, different communication protocol. In the first mating orientation, the first communication protocol may be USB 10 Gbps or higher and the second communication protocol may be USB 2.0. In the second mating orientation, the first communication protocol may be USB 2.0 and the second communication protocol may be USB 10 Gbps or higher. In other examples, the USB2.0 (480 Mbps) protocol instead could be USB1.1 (12 Mbps). Similarly, the 10 Gbps protocol could instead be 5 Gbps as well.

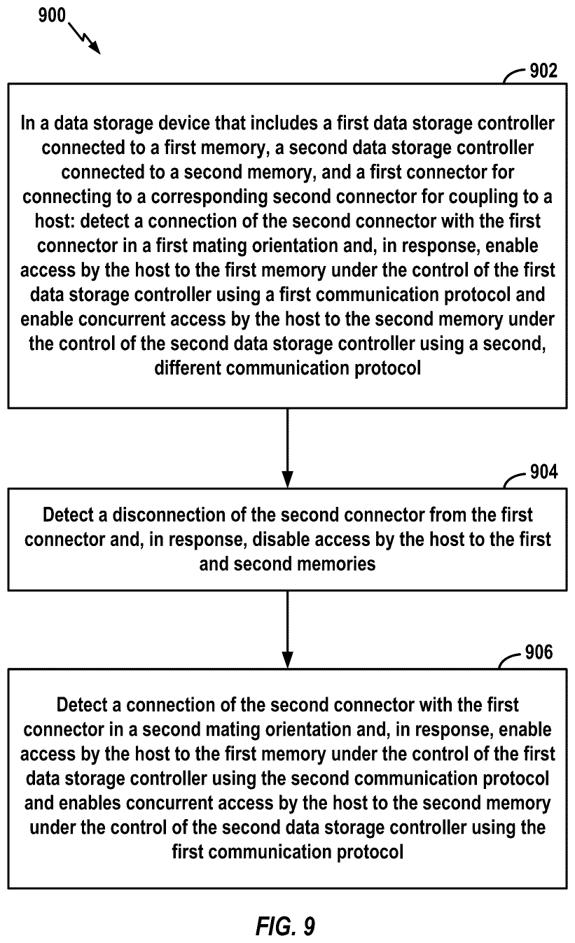

FIG. 9 illustrates a method or process 900 in accordance with some aspects of the disclosure for use by data storage device that includes a first data storage controller connected to a first memory, a second data storage controller connected to a second memory, and a first connector for connecting to a corresponding second connector coupled to a host. At block 902, the data storage device detects a connection of the second connector with the first connector in a first mating orientation and, in response, enables access by the host (e.g. via an external cable having the second connector) to the first memory under the control of the first data storage controller using a first communication protocol and enables concurrent access by the host (e.g., via the external cable) to the second memory under the control of the second data storage controller using a second, different communication protocol. At block 904, the data storage device detects disconnection of the second connector from the first connector and, in response, disables access by the host to the first and second memories. At block 906, the data storage device detects a connection of the second connector with the first connector in a second mating orientation and, in response, enables access by the host to the first memory under the control of the first data storage controller using the second communication protocol and enables concurrent access by the host to the second memory under the control of the second data storage controller using the first communication protocol. In the first mating orientation, the first communication protocol may be USB 10 Gbps or higher and the second communication protocol may be USB 2.0. In the second mating orientation, the first communication protocol may be USB 2.0 and the second communication protocol may be USB 10 Gbps or higher. In other examples, the USB2.0 (480 Mbps) protocol instead could be USB1.1 (12 Mbps). Similarly, the 10 Gbps protocol could instead be 5 Gbps as well.

Exemplary SSD with 20 Gbps and 480 Mbps Access to Two Separate Memory Spaces

As noted above, an SSD is provided that uses USB Type-C (“USB-C”) connection cables (or similar) to provide 20 Gbps communications (e.g. data transfer) with a host using the Tx/Rx lines of the cable in accordance with a USB 3.2 Gen 2×2 or higher (above), while concurrently providing 480 Mbps communications (e.g. data transfer) with the host in accordance with USB 2.0 over or using the D+/D− lines of the connector. For example, the SSD may have: a first data storage controller connected to the Tx/Rx lines to provide 20 Gbps access by the host to a first memory space composed of a first set of NANDs or DRAMs; and a second data storage controller connected to the D+/D− lines to provide concurrent 480 Mbps access by the host to a second memory space composed of a second set of NANDs or DRAMs. In other examples, USB 3.0 or 3.1 may be used instead of USB 3.2 Gen 2×2, though with slower overall speeds (e.g., 5 Gbps or 10 Gbps for the connection via the Tx/Rx lines). In still other examples, USB4 or faster protocols may be used. In still other examples, other suitable connection cables may be used such as Thunderbolt 3 and Thunderbolt 4.

Note that the first controller of the SSD is connected to all of the Tx/Rx pins of its USB-C connector so that first controller can concurrently use both of the SuperSpeed communication lanes in any CC orientation (i.e., using TX1+/TX1−, RX1+/RX1−, TX2+/TX2−, and RX2+/RX2−), thus achieving 20 Gbps performance with USB 3.2 Gen2×2 for the first memory space. The second controller of the SSD operates with a USB 2.0 connection using D+/D− for 480 Mbps (Hi-Speed USB) communications. Notably, this is achieved regardless of the orientation of the USB cable in the USB connector of the SSD. That is, the user may insert the reversible USB-C cable plug into the USB-C socket of the SSD in cither orientation and, regardless of the orientation, the first controller is connected to the Tx/Rx pins for SuperSpeed access by the host and the second controller is connected to at least one pair of D+/D− pins for 480 Mbps (Hi-Speed access) by the host.

Furthermore, when the SSD is connected to the host, the File Explorer of the host is configured to show two external drives in addition to the local disk C (which includes the host's OS). The first of the two external drives (e.g., an F: drive) corresponds to the memory space of the first set of NANDs (or DRAMs) accessible at 20 Gbps, and the second of the two external drives (e.g., a G: drive) corresponds to the memory space of the second set of NANDs (or DRAMs) accessible at 480 Mbps. The two memory spaces may be of the same or different sizes. In one example, each memory space has four NAND chips, each with 2 TB, to provide 8 TB per memory space and 16 TB for the entire external drive.

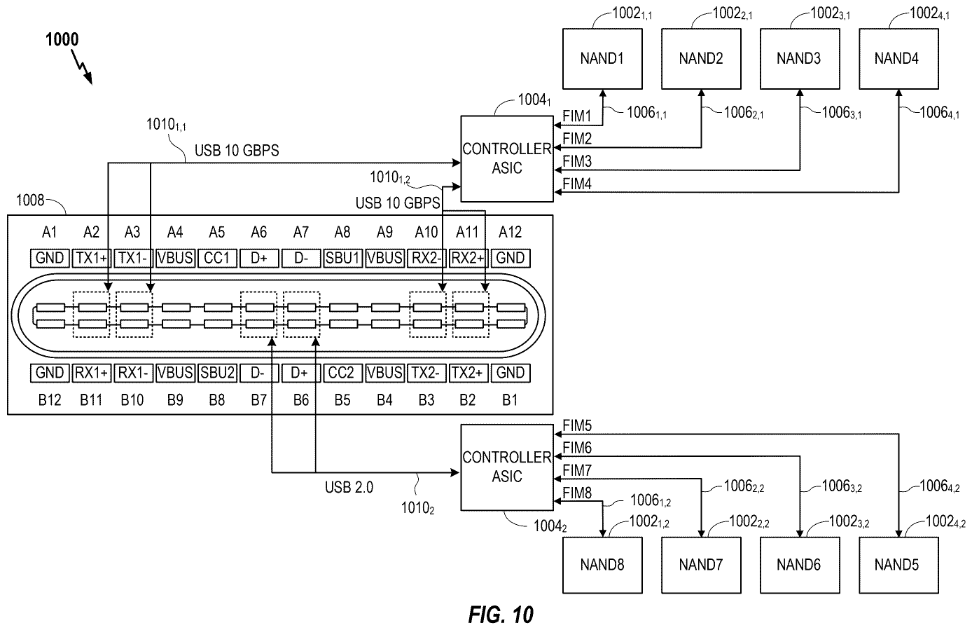

FIG. 10 illustrates an SSD 1000 configured in accordance with aspects of the present disclosure wherein a first storage controller is connected to the Tx/Rx lines for 20 Gbps communications (e.g., using USB 3.2 Gen 2×2) and a second storage controller is connected to the D+/D− lines for 480 Mbps communications (e.g., using USB 2.0). Each data storage controller is connected to four 2 TB NAND chips, thus providing a total memory capacity of 16 TB. More specifically, SSD 1000 has a first set of four NAND chips 1002_{1.1}-1002_{4.1} connected to a first data storage controller 1004₁ via four FIM channels 1006_{1.1}-1006_{4.1}. SSD 1000 also has a second set of four NAND chips 1002_{1.2}-1002_{4.2} connected to a second data storage controller 1004₂ via four FIM channels 1006_{1.2}-1006_{4.2}. The SSD 1000 also includes a USB-C connector socket (or receptable) 1008 (see, again, FIG. 2) that accommodates two SuperSpeed communication lanes (each at 10 Gbps for USB 3.2 Gen 2×2) and one Hi-Speed communication lane (USB 2.0).

A first USB 10 Gbps communication lane 1010_{1.1} is connected from the data storage controller 1004₁ to the pins of the USB-C connector socket 1008, including to the TX1+, TX1−, RX1+, and RX1− pins as explicitly shown, for full-duplex SuperSpeed USB 10 Gbps transmissions along a first lane corresponding to those pins. A second USB 10 Gbps communication lane 1010_{1.2} is connected from the data storage controller 1004₁ to the pins of the USB-C connector socket 1008, including to the TX2+, TX2−, RX2+, and RX2− pins as explicitly shown, for full-duplex SuperSpeed USB 10 Gbps transmissions along a second lane corresponding to those pins. A USB 2.0 communication lane 1010₂ is connected from the second data storage controller 1004₂ to the pins of the USB-C connector socket 1008, including to the D− and D+ pins as explicitly shown, for half-duplex 480 Mbps transmissions along a Hi-Speed lane corresponding to those pins.

Note that both data storage controllers may be connected to all of the pins of the USB-C connector socket 1008, including GND pins, CC pins, etc., to allow proper communication with the host, including initial host/device negotiation operations such as CC detection, power and current negotiation, data role negotiation, etc. These other connections between the two ASICs and the pins are not explicitly shown in the figure, which instead highlights the connections to the TX/RX and D+/D− pins that are used for the different communication lanes. Although the first data storage controller 1004₁ may be connected to the D+/D− pins while a USB plug is plugged into the socket 1008, the first data storage controller 1004₁ does not interfere with USB 2.0 communications sent over the D+/D− lane under the control of the second data storage controller 1004₂. Likewise, although the second data storage controller 1004₂ may be connected to the Rx/Tx pins while the USB plug is inserted in the socket 1008, the second data storage controller 1004₂ does not interfere with USB 20 Gbps communications sent over the TX/RX lanes under the control of the first data storage controller 1004₁. In this manner, concurrent communications may be sent over the three communication lanes (1010_{1.1}, 1010_{1.2} and 1010₂) to provide 20 Gbps plus an additional 480 Mbps.

Moreover, note that that the three communication lanes may be concurrently used regardless of the orientation of the USB plug into the USB socket. As shown in FIG. 2B, the USB-C plug configuration is different than the socket configuration, and so the D+/D− pins of the plug may connect to either the A6/A7 pins of the socket or the B6/B7 pins of the socket, depending upon the orientation of the plug. The second data storage controller 1004₂ then uses whichever D+/D− pins are electrically coupled to the D+/D− pins of the plug for USB 2.0 communications. Both the plug and socket have upper and lower TX/RX pins and so, regardless of plug orientation, the first data storage controller 1004₁ can access both pairs of TX/RX pins to provide two 10 Gbps communication lanes. Note also that since the D+/D− lane includes only one differential pair, the D+/D− lane is a half-duplex lane. The TX1+/TX1−/RX1+/RX1− lane is full-duplex, with separate receive and transmit lines. Likewise, the TX2+/TX2−/RX2+/RX2− lane is full-duplex.

Although not shown in FIG. 10, each of the two data storage controllers 1004₁, 1004₂ includes frontend components that implements the appropriate USB-C-compatible protocol (e.g., either USB 3.2 Gen 2×2 or USB 2.0) for use with the USB-C connector socket 1008 and backend components that interface with the corresponding FIM channels that connect to the corresponding NAND chips of the SSD for storing (programming) data to the NAND chips and for reading out (sensing) data from the NAND chips. Note though that, since the second data storage controller 1004₂ uses only USB 2.0 480 Mbps communication in this embodiment (regardless of the plug orientation), the second data storage controller 1004₂ need not be configured for 20 Gbps processing and therefore may be a smaller and less expensive ASIC (and may also consume less power) than the first data storage controller 1004₁. Moreover, the two sets of NANDs and FIMs may differ from one another. For example, the set of NANDs and FIMs for use with the second data storage controller 1004₂ may be generally slower than those used with the first data storage controller 1004₁ since they do not need to accommodate the much higher speeds used by the first data storage controller 1004₁.

Note that the USB2.0 (480 Mbps) lane/protocol could be USB 1.1 (12 Mbps). That is, it could be USB 2.0/1.1. Similarly, the two 10 Gbps lanes could instead each be a 5 Gbps lane. Hence, the USB 2.0/USB 10 Gbps configuration is just one example. Still further, faster speeds (e.g., 80 Gbps) can be accommodated as well with suitable ASICs, etc. As with the embodiments described above, one set of NAND chips may be used by a user for personal data (e.g., videos, computer game data, etc.), while the other set of NAND chips may be used for work data (e.g., spreadsheets, etc.) In other examples, one set of NAND chips may be used by the user for primary data storage while the other set of NAND chips may be used for data backup.

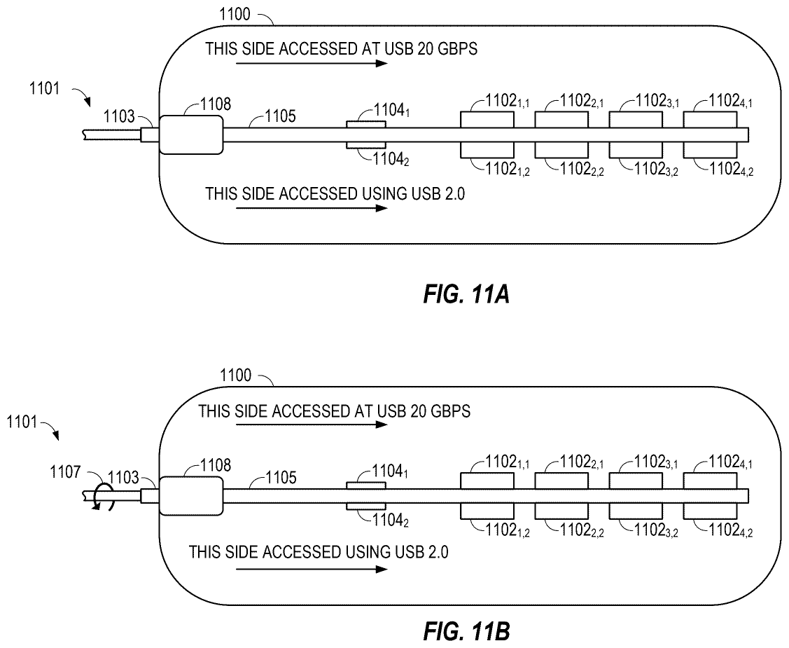

FIGS. 11A and 11B illustrate that one “side” of the SSD is accessed using USB 20 Gbps while the other side is accessed using USB 2.0, regardless of the orientation of the plug.

FIG. 11A illustrates an SSD 1100 with a USB-C cable 110₁ having a USB-C cable plug 1103 inserted into a USB-C cable socket 1108. Although not shown in the figure, the opposite end of the USB-C cable 110₁ is connected into a host. In the orientation of FIG. 11A, a data storage controller 1104₁ is enabled to provide access by the host to a first set of NAND chips 1102_{1.1}-1102_{4.1} with data transfers to/from the host performed using USB 20 Gbps while a data storage controller 1104₂ is enabled to provide access by the host to a second set of NAND chips 1102_{1.2}-1102_{4.2} with data transfers to/from the host performed using USB 2.0. Note that the figure shows a central bar 1105 that conceptually represents various connection lanes, busses and/or FIMs that interconnect the various components. Notably, as explained above, separate FIMs and connection lanes are provided for the two separate data storage controllers and their corresponding NAND chips. For clarity, the separate lanes, FIMS, etc., are omitted.

FIG. 11B illustrates the SSD 1100 with the USB-C cable 110₁ flipped (as shown by arrow 1107) with its USB-C cable plug 1103 inserted into the USB-C cable socket 1108 in the opposite orientation. In the configuration of FIG. 11B, data storage controller 1104₁ is still enabled to provide access by the host to the first set of NAND chips 1102_{1.1}-1102_{4.1} with data transfers to/from the host performed using USB 20 Gbps while data storage controller 1104₁ is still enabled to provide access by the host to the second set of NAND chips 1102_{1.2}-1102_{4.2} with data transfers to/from the host performed using USB 2.0.

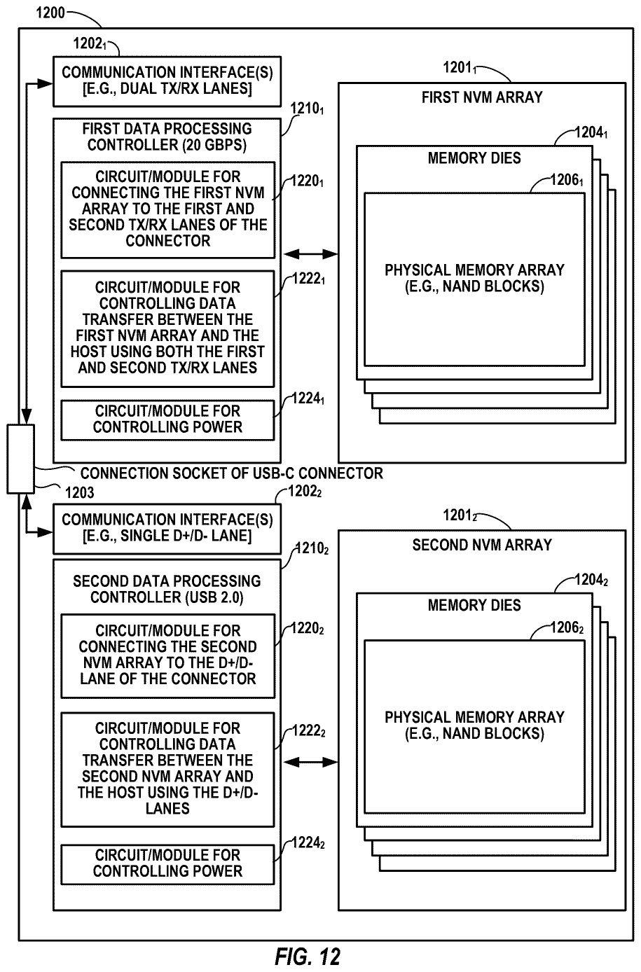

FIG. 12 illustrates an embodiment of an apparatus 1200 configured according to one or more aspects of the disclosure. The apparatus 1200, or components thereof, could embody or be implemented as a data storage controller within a portable SSD, or other type of device that supports computations and data storage.

A first data processing controller 1210₁ is communicatively coupled to a first NVM die array 1201₁ that includes one or more memory dies 1204₁, each of which may include physical memory arrays 1206₁, e.g., NAND blocks. The data processing controller 1210₁ may include various modules/circuits, including FW components. These components can be coupled to and/or placed in electrical communication with one another and with the NVM die array 1201₁ via suitable components, represented generally by connection lines in FIG. 12. A second data processing controller 1210₂ is communicatively coupled to a second NVM die array 1201₂ that includes one or more memory dies 1204₂, each of which may include physical memory arrays 1206₂, e.g., NAND blocks. The data processing controller 1210₂ may also include various modules/circuits, including FW components. These components can be coupled to and/or placed in electrical communication with one another and with the NVM die array 1201₂ via suitable components, represented generally by connection lines in FIG. 12. Although not shown, other circuits such as timing sources, peripherals, voltage regulators, and power management circuits may be provided, which are well known in the art, and therefore, will not be described any further.

In some examples, the memory dies may include on-chip circuitry such as under-the-array circuitry. The memory dies 1204₁ may be communicatively coupled to the data processing controller 1210₁ such that the apparatus 1200 can read or sense information from, and write or program information to, the physical memory array 1206₁. That is, the physical memory array 1206₁ can be coupled to controller 1210₁ so that the physical memory array 1206₁ is accessible by the controller 1210₁. The dies may additionally include, e.g., input/output components, registers, voltage regulators, etc. The connection between the controller 1210₁ and the memory dies 1204₁ of the NVM die array 1201₁ may include, for example, one or more busses. Likewise, the memory dies 1204₂ may be communicatively coupled to the data processing controller 1210₂ such that the apparatus 1200 can read or sense information from, and write or program information to, the physical memory array 1206₂. That is, the physical memory array 1206₂ can be coupled to controller 1210₂ so that the physical memory array 1206₂ is accessible by the controller 1210₂. The connection between the controller 1210₂ and the memory dies 1204₂ of the NVM die array 1201₂ may include, for example, one or more busses.

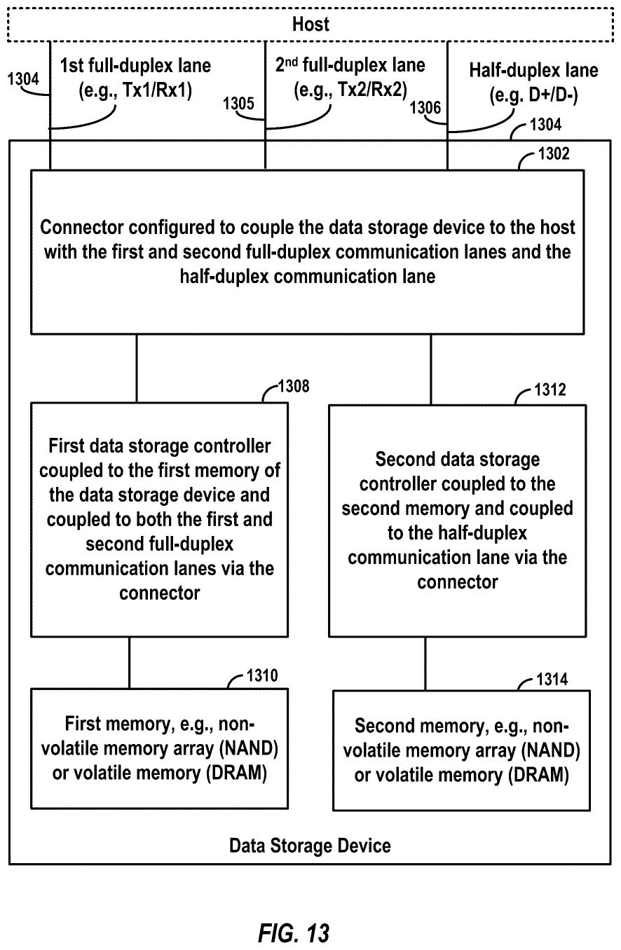

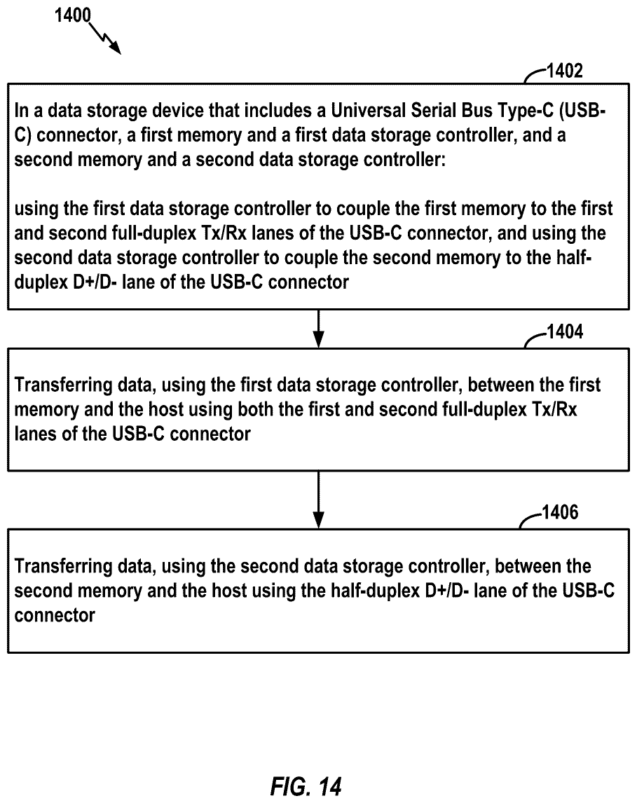

The apparatus 1200 includes a first communication interface 1202₁, e.g. a pair of first and second full-duplex Tx/Rx lanes for connecting via USB-C socket 1203 of a USB-C connector to a laptop, a mobile phone, etc. using, e.g., USB 3 or higher compatible protocols (such as USB 20 Gbps) or other suitable communication protocols. The modules/circuits of the data storage controller 1210₁ are arranged or configured to obtain, process, and/or send data, control data access and storage, issue or respond to commands, and control other desired operations. For example, the controller 1210₁ may be implemented as one or more processors, configured individually or in combination, one or more controllers, and/or other structures configured to perform functions. According to one or more aspects of the disclosure, the controller 1210₁ may be adapted to perform any or all of the features, processes, functions, operations, and/or routines described herein as being performed by the controller ASIC 1004₁ of FIG. 10 or any of the USB 3.x or higher compatible controllers described herein. For example, the controller 1210₁ may be configured to perform any of the data storage controller steps, functions, and/or processes described with respect to the first controller of FIG. 10 and that of FIGS. 13-14, discussed below.

The apparatus 1200 also includes a second communication interface 1202₂, e.g. a half-duplex D+/D− lane for connecting via USB-C socket 1203 of a USB-C connector to a laptop, a mobile phone, etc. using, e.g., USB 2.0 compatible protocols (such as 480 Mbps) other suitable communication protocols. The modules/circuits of the data storage controller 1210₂ are arranged or configured to obtain, process, and/or send data, control data access and storage, issue or respond to commands, and control other desired operations. For example, the controller 1210₂ may be implemented as one or more processors, configured individually or in combination, one or more controllers, and/or other structures configured to perform functions. According to one or more aspects of the disclosure, the controller 1210₂ may be adapted to perform any or all of the features, processes, functions, operations, and/or routines described herein as being performed by the controller ASIC 1004₂ of FIG. 10 or any of the USB 2.0 compatible controllers described herein. For example, the controller 1210₂ may be configured to perform any of the data storage controller steps, functions, and/or processes described with respect to the second controller of FIG. 10 and that of FIGS. 13-14, discussed below.

According to at least one example of the apparatus 1200, the data processing controller 1210₁ may include one or more of: a circuit/module 1220₁ for coupling or connecting the first NVM array 1201₁ to the first and second Tx/Rx lanes of the USB-C connector; a circuit/module 1222₁ for controlling data transfer between the first NVM array 1201₁ and the host using both the first and second Tx/Rx lanes of the USB-C connector; and a circuit/module 1224₁ for controlling power of the first controller 1210₁. The data processing controller 1210₂ may include one or more of: a circuit/module 1220₂ for coupling or connecting the second NVM array 1201₂ to the D+/D− lane of the USB-C connector; a circuit/module 1222₂ for controlling data transfer between the second NVM array 1201₂ and the host using the D+/D− lane of the USB-C connector; and a circuit/module 1224₂ for controlling power of the second controller 1210₂.

In at least some examples, means may be provided for performing the functions illustrated in FIG. 12 and/or other functions illustrated or described herein. For example, the means may include one or more of: means, such as circuit/module 1220₁, for coupling or connecting the first NVM array 1201₁ to the first and second full-duplex Tx/Rx lanes of the USB-C connector; means, such as circuit/module 1222₁, for transferring data between the first NVM array 1201₁ and the host using both the first and second full-duplex Tx/Rx lanes of the USB-C connector; means, such as circuit/module 1224₁, for controlling power of the first controller 1210₁; means, such as circuit/module 1220₂, for coupling or connecting the second NVM array 1201₂ to the half-duplex D+/D− lane of the USB-C connector; means, such as circuit/module 1222₂, for transferring between the second NVM array 1201₂ and the host using the half-duplex D+/D− lane of the USB-C connector; and means, such as circuit/module 1224₂, for controlling power of the second controller 1210₂.

FIG. 13 is a block diagram of an exemplary data storage device 1300 in accordance with some aspects of the disclosure. The data storage device 1300 includes: a connector 1302 (such as a USB-C connector) configured to connect the data storage device to a host with the connector 1302 configured to couple the data storage device 1300 to the host with a first full-duplex communication lane 1304 (e.g., Tx1/Rx1), a second full-duplex communication lane 1305 (e.g., Tx2/Rx2), and a half-duplex communication lane 1306 (e.g. a D+/D− lane). The data storage device 1300 also includes: a first data storage controller 1308 coupled to a first memory 1310 (which may be an NVM such as a NAND or a volatile memory such as a DRAM) and coupled to the connector 1302. The data storage device 1300 also includes: a second data storage controller 1312 coupled to a second memory 1314 (which also may be an NVM such as a NAND or a volatile memory such as a DRAM) and coupled to the connector 1302.

The three communication lanes (1304, 1305, and 1306) operate to communicatively couple the data storage device 1302 to the host for concurrent communication on all three lanes. The first and second full-duplex communication lanes may each be used for, e.g., 10 Gbps communications in accordance with USB 3.2 or higher. The half-duplex communication lane may be used for, e.g., 480 Mbps communications in accordance with USB 2.0.

FIG. 14 illustrates a method or process 1400 in accordance with some aspects of the disclosure for use by data storage device that includes a USB-C connector, a first memory and a first data storage controller, and a second memory and a second data storage controller. At block 1402, the data storage device uses the first data storage controller to couple the first memory to the first and second full-duplex Tx/Rx lanes of the USB-C connector, and uses the second data storage controller to couple the second memory to a half-duplex D+/D− lane of the USB-C connector. At block 1404, the data storage device uses the first data storage controller to transfer data between the first memory and the host using both the first and second full-duplex Tx/Rx lanes of the USB-C connector. At block 1406, the data storage device uses the second data storage controller to transfer data between the second memory and the host using the half-duplex D+/D− lane of the USB-C connector. The operations of blocks 1404 and 1406 may be concurrent. Transference of data using the first and second full-duplex Tx/Rx lanes may be at 10 Gbps (or higher) for each lane (e.g., 20 Gbps for both lanes) in accordance with USB 3.2 Gen 2×2 or higher, while concurrent transference of data using the half-duplex D+/D− lanes may be at 480 Mbps in accordance with USB 2.0. In other examples, the USB2.0 (480 Mbps) protocol instead could be USB1.1 (12 Mbps). Similarly, the 10 Gbps protocol could instead be 5 Gbps, or faster rates such as 40 Gbps or 80 Gbps.

Although SSDs configured for use with USB cables are described herein as exemplary embodiments, it should be understood that SSDs configured for use with other compatible cables may be used instead. Generally speaking, connectors or cables configured to couple an SSD to a host with first and second full-duplex communication lanes and a half-duplex communication lane may be used, with a first data storage controller of the SSD coupled to both the first and second full-duplex communication lanes of the connector and a second data storage controller of the SSD coupled to the half-duplex communication lane of the connector. Examples of other cables include Thunderbolt 3, Thunderbolt 4, and USB4. Aspects described herein may also be applicable to the PCIe interface.

Moreover, the discussions above regarding thumb drives are applicable to the embodiments of FIGS. 10-14 as well. That is, the SSD may be connected to a host via a cable or the SSD might be configured as a thumb drive (or memory stick, pen drive, etc.) for directly attaching to a host, depending upon the particular communication protocol or interface. (For USB-C, since the pinout of a USB-C plug is different from the pinout of a USB-C socket, some of the devices and procedures described herein might not work with a thumb drive configured with only a USB-C plug. This may depend on whether the plug is provided with two pairs of D+ and D− pins, as with the socket.

### Additional Aspects

Aspects of the subject matter described herein can be implemented in any suitable NAND flash memory, such as 3D NAND flash memory. Semiconductor memory devices include volatile memory devices, such as DRAM) or SRAM devices, NVM devices, such as ReRAM, EEPROM, flash memory (which can also be considered a subset of EEPROM), ferroelectric random access memory (FRAM), and MRAM, and other semiconductor elements capable of storing information. Sec, also, 3D XPoint (3DXP)) memories. Each type of memory device may have different configurations. For example, flash memory devices may be configured in a NAND or a NOR configuration.

In addition to data storage devices, the NVM arrays (and associated circuitry and latches, where appropriate) in various described embodiments may be implemented as part of memory devices such as dual in-line memory modules (DIMMs) or other types of memory components/modules in some embodiments. Such memory devices may be accessible to a processing component such as a Central Processing Unit (CPU) or a Graphical Processing Unit (GPU). The links between processing components to such memory devices may be provided via one or more memory or system buses, including via interconnects such as Compute Express Link (CXL), Gen-Z, OpenCAPI, NVLink/NVSwitch, Infinity Fabric, Omni-Path, and other similar interconnect protocols. In other embodiments, the links between processing components to memory devices may be provided via on-die or die-to-die interconnects. In certain embodiments, the NVM arrays and associated circuitry may be co-located on the same die as the processing components such as CPU or GPU. In other examples, data may be stored in as hard disk drives (HDDs) or hybrid drives, etc.

Regarding the application of the features described herein to other memories besides NAND: NOR, 3DXP, PCM, and ReRAM have page-based architectures and programming processes that usually require operations such as shifts, XORs, ANDs, etc. If such devices do not already have latches (or their equivalents), latches can be added to support the latch-based operations described herein. Note also that latches can have a small footprint relative to the size of a memory array as one latch can connect to many thousands of cells, and hence adding latches does not typically require much circuit space.

The memory devices can be formed from passive and/or active elements, in any combination. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bitline and accessed as a group. Alternatively, memory elements may be configured so that each element is individually accessible, e.g., a NOR memory array. NAND and NOR memory configurations are exemplary, and memory elements may be otherwise configured. The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-y direction plane) which extends substantially parallel to a major surface of a substrate that supports the memory elements. The substrate may be a wafer over or in which the layer of the memory elements is formed or it may be a carrier substrate that is attached to the memory elements after they are formed. As a non-limiting example, the substrate may include a semiconductor such as silicon. The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bitlines and word lines.

A three-dimensional memory array is arranged so that memory elements occupy multiple planes or multiple memory device levels, thereby forming a structure in three dimensions (i.e., in the x, y and z directions, where the z direction is substantially perpendicular and the x and y directions are substantially parallel to the major surface of the substrate). As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the z direction) with each column having multiple memory elements in each column. The columns may be arranged in a two-dimensional configuration, e.g., in an x-y plane, resulting in a three-dimensional arrangement of memory elements with elements on multiple vertically stacked memory planes. Other configurations of memory elements in three dimensions can also constitute a three-dimensional memory array.

By way of a non-limiting example, in a three-dimensional NAND memory array, the memory elements may be coupled together to form a NAND string within a single horizontal (e.g., x-y) memory device level. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements that span through multiple memory levels. Three-dimensional memory arrays may also be designed in a NOR configuration and a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two-dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements. One of skill in the art will recognize that the subject matter described herein is not limited to the two-dimensional and three-dimensional exemplary structures described but covers all relevant memory structures within the spirit and scope of the subject matter as described herein and as understood by one of skill in the art.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatus, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer-readable medium having stored thereon computer-executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application-specific integrated circuits. In addition, a computer-readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” is intended to cover A, B, C, A-B, A-C, B-C, and A-B-C, as well as multiples of the same members (e.g., any lists that include AA, BB, or CC). Likewise, “at least one of: A, B, and C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

As used herein, the term “determining” encompasses a wide variety of actions. For example, “determining” may include calculating, computing, processing, deriving, investigating, looking up (e.g., looking up in a table, a database, datastore, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A data storage device, comprising:
a connector configured to couple the data storage device to a host with first and second full-duplex communication lanes and a half-duplex communication lane;
a first data storage controller coupled to a first memory of the data storage device and coupled to both the first and second full-duplex communication lanes of the connector; and
a second data storage controller coupled to a second memory of the data storage device and coupled to the half-duplex communication lane of the connector.

2. The data storage device of claim 1, wherein:
the first and second full-duplex communication lanes and the half-duplex communication lane are configured for concurrent communications with the host;
the first data storage controller is configured to transfer data to the host over the first and second full-duplex communication lanes in accordance with a first communication protocol; and
the second data storage controller is configured to transfer data to the host over the half-duplex communication lane in accordance with a second, different communication protocol.

3. The data storage device of claim 2, wherein:
the first communication protocol is Universal Serial Bus (USB) 3.0 or higher; and
the second communication protocol is USB 2.0.

4. The data storage device of claim 1, wherein:
the connector comprises a Universal Serial Bus Type-C (USB-C) connector;
the first full-duplex communication lane comprises a first Tx/Rx lane of the USB-C connector;
the second full-duplex communication lane comprises a second Tx/Rx lane of the USB-C connector; and
the half-duplex communication lane comprises a D+/D− lane of the USB-C connector.

5. The data storage device of claim 4, wherein the first data storage controller is configured to transfer data to the host using USB 3.2 Gen 2×2 or higher using the first and second Tx/Rx lanes of the USB-C connector.

6. The data storage device of claim 4, wherein:
the first data storage controller is configured to transfer data to the host at 10 giga-bits-per-second (Gbps) or higher using the first Tx/Rx lane of the USB-C connector and at 10 Gbps or higher using the second Tx/Rx lane of the USB-C connector; and
the second data storage controller is configured to transfer data to the host at 480 mega-bits-per-second (Mbps) using the D+/D− lane of the USB-C connector.

7. The data storage device of claim 4, wherein the USB-C connector of the data storage device is a USB-C socket configured to mate with a USB-C plug.

8. The data storage device of claim 4, wherein the USB-C connector of the data storage device is a USB-C plug configured to mate with a USB-C socket.

9. The data storage device of claim 1, wherein:
the first memory comprises a first plurality of NAND chips or dynamic random access memory (DRAM) chips; and
the second memory comprises a second plurality of NAND chips or DRAM chips.

10. A computing system comprising:
the data storage device of claim 1; and
a host communicatively coupled to the data storage device, wherein the host is configured to display the first memory of the data storage device to a user as a first external drive and to display the second memory of the data storage device to the user as a second external drive.

11. A method for use by a data storage device that includes a connector, a first memory and a first data storage controller, and a second memory and a second data storage controller, the method comprising:
using the first data storage controller to couple the first memory to first and second full-duplex communication lanes of the connector;
using the second data storage controller to couple the second memory to a half-duplex communication lane of the connector;
transferring data, using the first data storage controller, between the first memory and a host using both the first and second full-duplex communication lanes of the connector; and
transferring data, using the second data storage controller, between the second memory and the host using the half-duplex communication lane of the connector.

12. The method of claim 11, wherein the transferring of data between the first memory and the host using both the first and second full-duplex communication lanes of the connector is performed concurrently with the transferring of data between the second memory and the host using the half-duplex communication lane of the connector.

13. The method of claim 11, wherein:
the transferring of data between the first memory and the host using both the first and second full-duplex communication lanes is performed in accordance with a first communication protocol; and
the transferring of data between the second memory and the host using the half-duplex communication lane is performed in accordance with a second, different communication protocol.

14. The method of claim 13, wherein the first communication protocol is Universal Serial Bus (USB) 3.0 or higher, and the second communication protocol is USB 2.0.

15. The method of claim 11, wherein:
the connector is a Universal Serial Bus Type-C (USB-C) connector;
the first full-duplex communication lane is a first Tx/Rx lane;
the second full-duplex communication lane is a second Tx/Rx lane;
the half-duplex communication lane is a D+/D− lane; and
data is transferred between the first memory and the host using both the first and second Tx/Rx lanes of the USB-C connector while data is concurrently transferred between the second memory and the host using the D+/D− lane.

16. The method of claim 15, wherein:
the transferring of data between the first memory and the host using both the first and second Tx/Rx lanes of the USB-C connector is performed using USB 3.0 or higher; and
the transferring of data between the second memory and the host is performed using USB 2.0 using the D+/D− lane of the USB-C connector.

17. The method of claim 16, wherein the transferring the data between the first memory and the host using both the first and second Tx/Rx lanes of the USB-C connector is performed using USB 3.2 Gen 2×2 or higher.

18. The method of claim 11, wherein:
the transferring of data between the first memory and the host using the first full-duplex lane of the connector is performed at 10 giga-bits-per-second (Gbps) or higher;
the transferring of data between the first memory and the host using the second full-duplex lane of the connector is performed concurrently at 10 Gbps or higher; and
the transferring of data between the second memory and the host using the half-duplex lane of the connector is performed at 480 mega-bits-per-second (Mbps).

19. An apparatus comprising:
means within a first data storage controller for coupling a first memory to first and second full-duplex communication lanes of a connector;
means within a second data storage controller for coupling a second memory to a half-duplex communication lane of the connector;
means within the first data storage controller for transferring data between the first memory and a host using both the first and second full-duplex communication lanes of the connector; and
means within the second data storage controller for transferring data between the second memory and the host using the half-duplex communication lanes of the connector.

20. The apparatus of claim 19, wherein
the connector is a Universal Serial Bus-C (USB-C) connector;
the means for transferring data between the first memory and the host using both the first and second full-duplex lanes comprises means for transferring data using USB 3.0 or higher; and
the means for transferring data between the second memory and the host using the half-duplex lane comprises means for transferring data using USB 2.0.
